(19) United States
(12) Patent Application Publication
(10) Pub. No.: US 2025/0005225 A1
(43) Pub. Date: Jan. 2, 2025

(54) METHOD FOR PROVIDING AT LEAST ONE DESIGN CONFIGURATION OF A COMPRESSED-AIR SYSTEM

(71) Applicant: KAESER KOMPRESSOREN SE, Coburg (DE)

(72) Inventor: Florian WAGNER, Neuffen (DE)

(21) Appl. No.: 18/580,820

(22) PCT Filed: Jul. 20, 2022
(86) PCT No.: PCT/EP2022/070386

§ 371 Date: Jan. 19, 2024

(30) Foreign Application Priority Data
Jul. 20, 2021 (DE) 10 2021 118 771.0

(51) Int. Cl. G06F 30/20; G06F 30/18; G06F 111/04; G06F 111/20

(52) U.S. Cl. CPC G06F 30/20; G06F 30/18; G06F 2111/04; G06F 2111/20

(57) ABSTRACT

The invention relates to a method for providing at least one design configuration of a compressed air system (1) comprising at least two compressors (11,12) connected in parallel, wherein the method comprises the following steps. Receiving component data (Dk) by a computer, wherein the component data (Dk) comprises a compressor list (Lv) containing a plurality of compressors (V1, V2, . . . , Vn) of different types. Generating a branched data structure (B) by the computer. Generating compressed air system configuration data (DKonf1, DKonf2) by a computer indicating compressed air system configurations (Konf1, Konf2) in which two of the compressors from the compressor list (V1, V2, . . . , Vn) are connected in parallel. Calculating at least one quality value by the computer for at least one of the compressed air system configurations (Konf1, Konf2) based on the compressed air system configuration (Konf1, Konf2) and at least one technical parameter (Kt) of the compressors of the compressed air system configuration (Konf1, Konf2), wherein the at least one quality value indicates the quality of the compressed air system configuration (Konf1, Konf2) with respect to a quality criterion, preferably specified by a user. Providing at least one compressed air system configuration (Konf1, Konf2) with in each case at least one assigned quality value by the computer.

The present invention relates to a method for providing at least one design configuration of a compressed air system comprising at least two compressors connected in parallel.

Compressed air systems often consist of a large number of different components, namely components for the generation, preparation, storage and distribution of compressed air. In addition, modern compressed air systems often feature higher-level control of the components. Components for compressed air generation, namely one or more compressors, are often connected in parallel with each other, and each defines a compressed air path within the compressed air system. Components for the preparation, storage and distribution of compressed air are often connected in series with each other. Several parallel compressed air paths, each originating from a compressor, can be combined, in particular for compressed air preparation and/or compressed air storage, for example by providing a common compressed air tank into which several or all compressed air paths open and from which compressed air is distributed to one or more consumers.

When designing a compressed air system, components and their interconnection are selected for a (real) compressed air system, Manufacturers of compressed air components often offer a product portfolio with a large number of different series and models for compressed air components. Compressors sometimes differ significantly in their investment and operating costs, in their technical parameters, such as size, delivery pressure, delivery volume, and in the number of operating states and parameters that can be set. Operators of compressed air systems are also frequently offered a wide range of different products for components other than compressors. For the design of a compressed air system, there are therefore a large number of different options, wherein the combination and assembly of the components to form a compressed air system is a complex task that requires precise knowledge of the components and a great deal of experience.

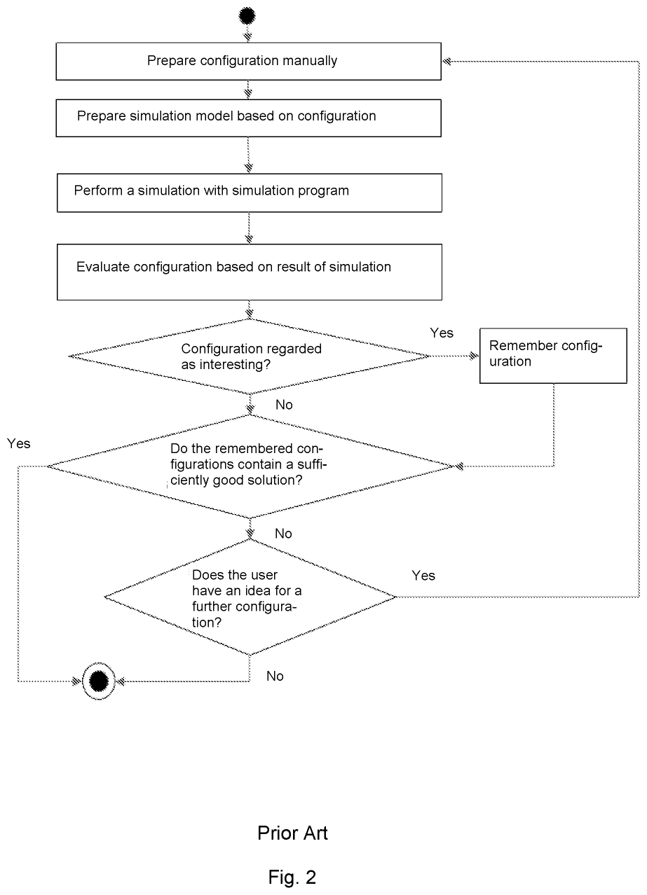

Typically, compressed air systems are largely designed manually, i.e. not (fully) automated. When designing a compressed air system, operators or suppliers (users) mentally design a possible configuration of the compressed air system, which is determined by the selected components and their interconnection. For this purpose, the user selects components from a product portfolio on the basis of the predetermined requirements and his experience and uses them to create a computer model of the configuration of the compressed air system (compressed air system configuration). Based on a simulation model, a computer simulation is then performed for this compressed air system configuration. Based on the simulation result, the configuration is evaluated by the user. The configuration is evaluated based on the fulfillment of the economic, i.e. cost, and technical requirements of the compressed air system. In an iterative process by repeating the described procedure, the user tries to gradually find the configuration that best meets the requirements. In this process, it is not guaranteed that the user will find the optimal solution for the configuration. The quality of the found compressed air configuration depends significantly on the available time and experience of the user. The creation of the configuration model as a basis for the simulation is time-consuming. The procedure is also sequential, so that the simulations of different configurations are carried out one after the other in time. Especially elaborate simulation models to generate accurate simulation results are expensive in terms of computer resources. One such well-known manual procedure for designing a compressed air system is shown in FIG. 2.

From EP 2 902 930 A2 a system and a method are known to perform a recommendation for adding a component to an existing compressed air system in a partially automated way. However, this solution requires interaction with the user, namely via an interface (Graphical User Interface (GUI)). The user can create a virtual model for a compressed air system via the GUI itself. Alternatively, the user can scan barcodes placed on the components of an existing compressed air system, in which case a virtual model of the existing compressed air system is automatically created based on this user activity. In either case, however, human involvement is required in generating a model for a model to be simulated. This method creates some relief for the user in creating a configuration model by scanning barcodes of existing components. However, finding a suitable solution still depends on the user's mental activity and has the disadvantages previously described in this regard.

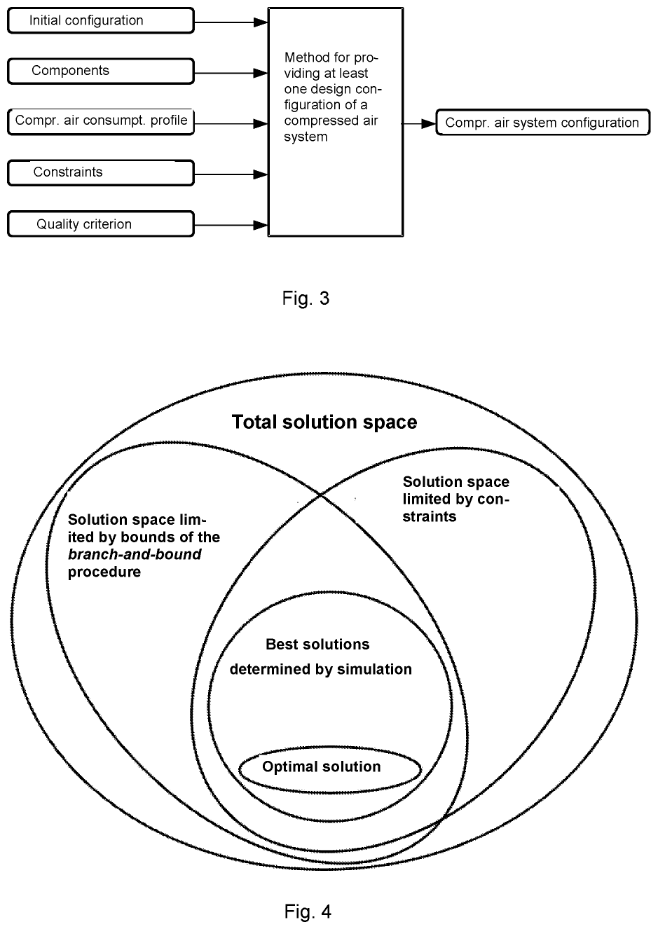

The publication Atlas Copco: Compressed air manual, 8th edition, Wilrijk, Atlas Copco Airpower NV, 2015, ISBN 978-9-08153-580-9, describes in chapter 3.1 various requirements of the operator to be considered when designing compressor stations for the production of compressed air. For the design of a compressor station, a procedure is illustrated in FIG. 3.2, which shows data collection, evaluation, operational analysis, calculation and simulation of considered compressor stations as steps to be performed. An operational analysis to determine compressed air demand is described as the basis for determining the optimum amount of compressed air to be produced. The operational analysis should include the measurement of operational data, for example over at least one week, and should preferably be supplemented by an analysis of a similar existing compressed air station. This measurement data allows to subsequently simulate different measures and changes in compressor operation and to analyze the influence on the overall efficiency of a compressor station. The procedure described is not automated and requires human involvement. Different compressor stations (i.e., each with a specific combination of compressors in a specific interconnection) are created manually based on an operational analysis and then simulated one after the other. Finding the most cost-effective compressor station is also based on human selection.

With regard to the control of compressed air systems, the publication Atlas Copco: Compressed air manual, 8th edition, Wilrijk: Atlas Copco Airpower NV, 2015, ISBN 978-9-08153-580-9, describes higher-level control systems or central control systems for compressor stations in chapters 2.5.6 and 2.5.7. In addition to a conventional sequence switch for compressor stations with 2-3 compressors, a further developed sequence switch with its own pressure sensor for the entire compressor station with 2-7 compressors is described as a higher-level control system. Central control systems have the task of maintaining the pressure within a narrow pressure band while controlling the connected compressors as economically as possible. For operational efficiency, it is important that the central control system always selects the most efficient compressor or compressor combination if the compressor station consists of compressors of different sizes. These higher-level and centralized control systems affect the start-up and shutdown of individual compressors (compressors) in existing compressor stations in operation. Individual compressors are thus selected for operation by the control system to the extent that they are switched on or off again to other existing compressors. The design of the compressed air system, i.e. the compressors actually present in the compressed air system and their interconnection, does not change.

WO 2010/072803 A1 describes a method for controlling or regulating a compressed air station with several interconnected compressors of different technical specifications and other compressed air technology devices. The method initiates switching strategies in control cycles to influence the available quantity of compressed air and, on the other hand, adaptively adjusts the available quantity of compressed air to future operating conditions of the compressed air station to the withdrawal quantity of compressed air. A switching strategy is understood to be a sequence of switching actions, i.e. a discrete or continuous change of manipulated variables, which cause a change in the operation of one or more components of the compressed air station. To initiate a switching strategy, various switching strategies are tested in a pre-simulation procedure based on a model of the compressed air station. Based on a defined quality criterion, the relatively most advantageous switching strategy is selected and forwarded to the system control of the compressed air station. This control procedure determines the operation of an existing compressed air system and considers various virtual operating states. The components that actually exist in the compressed air system and their interconnection remains unchanged.

Based on this prior art, the present invention has the object of creating a method for providing a design configuration of a compressed air system which shortens the time required for designing a compressed air system and preferably provides an optimum compressed air system configuration, optionally by taking into account the specifications of a user. In particular, the method is intended to minimize the necessary involvement of the user in the design of a compressed air system.

This object is solved by a method according to claim 1, a computer-readable storage medium according to claim 25, a server according to claim 26, and a terminal according to claim 27.

The object is solved in particular by a method, in particular a computer-assisted method, for providing at least one design configuration of a compressed air system comprising at least two compressors connected in parallel, wherein the method comprises the following steps:
Receiving component data by a computer, wherein the component data indicates components of a compressed air system and at least one technical parameter of each component, wherein the component data comprise at least one component list with a plurality of functionally identical components of different types and at least one technical parameter assigned to the respective component, wherein a component list is a compressor list containing a plurality of compressors of different types;
generating a branched data structure by the computer, which branched data structure comprises node data structures, which are each assigned to one of at least two node levels, wherein each child node data structure at a lower node level is assigned to a parent node data structure at a higher node level, wherein generating the branched data structure comprises at least the following steps:
   generating, in a memory, a first compressor parent node data structure based on component data of a compressor in the compressor list;
   generating, in the memory, a first compressor child node data structure based on component data of a compressor of the compressor list, wherein the first compressor child node data structure is assigned to the first compressor parent. node data structure;
   generating, in the memory, a second compressor child node data structure based on component data of a compressor of the compressor list, wherein the type of compressor of the second compressor child node data structure is different from the type of compressor of the first compressor child node data structure, wherein the second compressor child node data structure is assigned to the first compressor parent node data structure; or
   generating, in the memory, a second compressor parent node data structure based on component data of a compressor of the compressor list, wherein the type of the compressor of the second compressor parent node data structure is different from the type of the compressor of the first compressor parent node data structure, and generating, in the memory, a second compressor child node data structure based on component data of a compressor of the compressor list, wherein the second compressor child node data structure is assigned to the second compressor parent node data structure;
generating, by means of a computer, first compressed air system configuration data indicating a first compressed air system configuration in which the compressor of the first compressor parent node data structure and the compressor of the first compressor child node data structure are connected in parallel;
generating, by means of a computer, second compressed air system configuration data indicating a second compressed air system configuration in which the compressor of the first compressor parent node data structure or the compressor of the second compressor parent node data structure and the compressor of the second compressor child node data structure are connected in parallel;
calculating at least one quality value by the computer for at least one of the compressed air system configurations based on the compressed air system configuration data of the compressed air system configuration and at least one technical parameter of the compressors of the respective compressed air system configuration, wherein the at least one quality value indicates the quality of a compressed air system configuration with respect to a quality criterion, preferably specified by a user,
providing at least one compressed air system configuration, each with at least one assigned quality value, by the computer.

The invention is based on the idea that the multitude of conceivable combinatorial possibilities, preferably all combinatorial possibilities, of a set of available components of a compressed air system can be mapped in a (fully) automated manner by a computer with the aid of a branched data structure as different compressed air system configurations and can be evaluated using a computer, in particular systematically, with regard to a quality criterion. For the plurality of compressed air system configurations represented by the branched data structure, a quality value can be calculated by a computer in each case in order to evaluate the various compressed air configurations. Based on the evaluated compressed air system configurations, one or more suitable, preferably the (only) optimal, configuration(s) for the design of a compressed air system can be provided.

The branched data structure of the method according to the invention is generated in particular with the aid of a so-called branch-and-bound procedure by an algorithm. The branched data structure can be understood as an implementation of a tree that represents a hierarchical structure, which can be generated in particular by a recursive loop. Trees as branched data structures are basically known from computer science. Starting from a root node, the data structure of a tree branches out over several levels (node levels) of interconnected nodes further and further to the end nodes. At least one node (child node) at a relatively lower node level is connected to a node (parent node) at a relatively higher node level. The set of nodes connected to a node at a higher node level at lower node levels up to the end nodes is called a branch. A tree structure can be used to represent a discrete number of combinatorial possibilities (combinations). The nodes of the tree define the solution space in which an (optimal) solution can be found. To find an optimal solution, the combinations mapped by the nodes can be traversed (breadth-first search or depth-first search). Suboptimal combinations can be excluded at an early stage by suitable bounds. The size of the tree (number of nodes), and thus the combinations to be traversed, is thus efficiently limited.

In the branched data structure generated according to the invention, each node data structure in particular represents in each case a compressed air system configuration containing specific compressors and optionally further components of a compressed air system. In particular, a compressor parent node data structure and an assigned compressor child node data structure each represent parallel-connected compressors of a compressed air system configuration. In particular, the (all) compressors of a compressed air system configuration connected in parallel to each other are represented in the branched data structure along a node path (in the depth direction of the tree) of the compressor node data structures assigned (connected) to each other starting from the highest node level to a node at a lower node level. In this respect, the compressed air system configuration (uniquely) assigned to a particular compressor node data structure (compressor parent node data structure or compressor child node data structure) includes, in particular, the (all) compressors of those compressor node data structures, which, starting (upwards in the node hierarchy) from this particular compressor node data structure, in accordance with the (pairwise) assignments of the branched data structure (child-node-parent-node pairs), are present in each case on the next higher node level up to the highest node level (i.e. along a node path), i.e. have been generated in memory. In particular, the compressed air system configuration represented by an end node at the lowest node level contains all compressors along the (unique) node path up to the node at the highest node level. The same compressor node data structure may be referred to as a compressor child node data structure with respect to a higher node level and as a compressor parent node data structure with respect to a lower node level. Two different compressor node data structures (with two different node paths) represent two different compressed air system configurations.

The branched data structure generated according to the invention is generated (built) in particular by the repeated, preferably recursively repeated, generation of compressor node data structures, in particular until a termination criterion is met. The termination criterion takes into account in particular the quality value of the compressed air system configuration represented by a compressor node data structure. New compressor node data structures are generated in particular in a recursive loop until no further compressor node data structures can be generated due to a termination criterion. New compressor node data structures can be generated as compressor child node data structures of a lower node level relative to the node level of a compressor parent node data structure or as further compressor parent node data structures on the same node level of an already generated compressor parent node data structure, in particular until the termination criterion is met. The generation of further compressor node data structures may depend on constraints. In particular, the maximum number of node levels generated in the branched data structure may be limited by a maximum number of (parallel-connected) compressors, preferably as a constraint. The branched data structure comprises at least two and preferably up to three, further preferably up to five, further preferably up to ten, preferably up to 20 node levels. Accordingly, a compressed air system configuration to be designed may comprise two, preferably up to three, further preferably up to five, further preferably up to ten, further preferably up to 20 compressors, which are in particular connected in parallel to each other.

A compressed air system configuration specifies in particular the set of components of a compressed air system and their interconnection. A compressed air system configuration can be understood as a possible (virtual) arrangement of the components of a compressed air system, which is considered for the (optimal) design of a compressed air system. The design of a compressed air system includes in particular the new planning, modification and/or extension of the compressed air system. In the case of a new design, in particular, no (real) initial configuration of the compressed air system is available. The removal or replacement of a component of an existing compressed air system can be understood as a modification and the addition of a component as an extension of a compressed air system.

The designation components describes in particular components for compressed air generation (compressors), compressed air preparation (dryers, filters, oil separators), compressed air storage (compressed air tanks) and compressed air distribution. Components that perform the same function within a compressed air system are referred to as functionally identical components. For example, all compressors, even if they differ in type, have the same function, namely the compression (generation) of compressed air. The type of a component is preferably indicated by a (unique) type identifier (model number) of this component in a product portfolio. Accordingly, a compressor type may be a particular model or model variant of a compressor. Within the context of the invention, blowers can also be understood as compressors.

Component data contains in particular information about components, such as at least one technical parameter, preferably an energy consumption, and preferably at least one (unique) function identifier and one (unique) type identifier, in particular for (unique) identification of the component in a product portfolio. Component data may additionally contain economic parameters of a component, such as the investment costs (price). Component data originates in particular from a product database. The component data comprises in particular one or more component list(s). A component list contains several, preferably all, functionally identical components from a product portfolio that can be considered for use in a compressed air system. A component list can be understood as a data structure that specifies functionally identical components from a product catalog, with each component being assigned information about technical properties of that component and preferably about its costs. A component list can be understood as a concatenated list of data structures, each containing component data concerning a particular component. Component data may be received sequentially by a computer. In particular, parts (sublists) of component lists, especially parts of compressor lists, may be received sequentially. Received component data may have been sent by different sending devices.

One of the one or more component list(s) is a compressor list. In addition to (at least) one compressor list, the component data may include, for example, a dryer list, a filter list, and/or a compressed air tank list. The component data may comprise multiple compressor lists, with each compressor list containing in particular different models of a series of (similar) compressors. The component data for compressors may indicate information as to whether the particular type of compressor is a variable speed compressor. A compressor list may have a plurality of entries (list locations), for example, for more than five, preferably more than ten, further preferably more than 20, further preferably more than 30, further preferably more than 50, further preferably more than 100, further preferably up to 200, different compressors. The length of the compressor list (number of available compressors) and in particular the maximum number of compressors allowed in a compressed air system configuration (constraint), significantly determines the maximum size that the branched data structure can reach.

A quality value can in particular indicate estimated or calculated costs, preferably energy costs and/or investment costs and/or maintenance costs, of a compressed air system configuration. A quality value can indicate an energy consumption of the compressed air system. A quality value may be based on an, in particular predetermined, in particular received, energy price and/or CO₂ emission price. The calculation of the quality value can be based on at least one technical parameter of one, some or all components, in particular compressors, of a compressed air system configuration. The calculation of the quality value can (additionally) be based on at least one economic parameter of one, some or all components, in particular compressors, of a compressed air system configuration. For the calculation of a quality value, the branched data structure can be traversed in depth and/or in width to calculate an assigned quality value for the compressed air system configurations corresponding to the compressor node data structures. Preferably, quality values are calculated for compressed air system configurations already generated in the form of compressor node data structures while (simultaneously) the branched data structure is (further) built up, i.e. further compressor node data structures are generated.

In particular, at least a first quality value is calculated based on the first compressed air system configuration data and at least one technical parameter of the compressors of the first compressed air system configuration, wherein a first quality value indicates the quality of the first compressed air system configuration with respect to a quality criterion, preferably specified by a user. In particular, at least a second quality value is calculated based on the second compressed air system configuration data and at least one technical parameter of the compressors of the second compressed air system configuration, wherein the second quality value indicates the quality of the second compressed air system configuration with respect to the quality criterion.

Providing a compressed air configuration can be storing, in particular in a computer-readable memory, transmitting, in particular via a (wireless) data connection, or displaying, in particular by visualization through a display device (screen), the compressed air system configuration.

A (computer-aided) method according to the invention has the advantage that possible configurations of the compressed air system, which can be considered for the design, can be generated and evaluated (completely) automatically and quickly, in particular systematically. In particular, no participation of the user, especially no mental participation, of the user in the creation of possible configurations is necessary. The time required for the design of a compressed air system is thus greatly reduced. Furthermore, it can be guaranteed that the optimal design configuration is found.

In one embodiment, the method further comprises the steps of:
receiving constraint data by the computer, wherein the constraint data indicates at least one predetermined constraint, preferably by a user, for a compressed air system configuration, and determining, by means of the computer, based on the constraint data and the first compressed air system configuration data, whether the first compressed air system configuration satisfies the predetermined constraint and/or, based on the constraint data and the second compressed air system configuration data, whether the second compressed air system configuration satisfies the predetermined constraint. In particular, the at least one quality value is calculated if the respective compressed air system configuration satisfies the predetermined constraint. In particular, at least one first quality value is calculated if the first compressed air system configuration satisfies the predetermined constraint. In particular, at least a second quality value is calculated if the second compressed air system configuration fulfills the predetermined constraint. By checking constraints, it can be ensured that only those compressed air system configurations are considered for the design that fulfill the predetermined constraints. In particular, configurations that do not meet technical specifications for a new compressed air system to be planned, modified or expanded can thus be excluded as design configurations at an early stage. In particular, the calculation of the quality value is (only) performed if the constraint is fulfilled. This can save time and computing resources, especially if the calculation of the quality value is costly, in particular due to the execution of a simulation.

In one embodiment, the at least one predetermined constraint for a compressed air system comprises a maximum number of compressors and/or a maximum number of different compressor types and/or a specification as to whether variable speed compressors may or must be included. The terms “may” and “must” can be understood in each case as a specification of a user, in particular an operator of a compressed air system. Variable speed compressors place increased demands on the control system, so some users may wish to exclude such compressor types for the design of their compressed air system. On the other hand, variable speed compressors may be expressly desired by other users, for example to ensure particularly demand-oriented compressed air generation.

In one embodiment, the at least one predetermined constraint for a compressed air system comprises the maximum footprint of the compressed air system and/or a required minimum pressure of the compressed air system and/or a required maximum pressure of the compressed air system. In particular, a required minimum pressure is a main criterion for the design of a compressed air system.

In one embodiment, the at least one predetermined constraint for a compressed air system comprises a maximum investment budget, in particular for the new planning, modification or expansion of a compressed air system. A maximum investment budget refers in particular to the entire compressed air system with all installed components, in particular compressors. This makes it possible to exclude compressed air system configurations that are too expensive, even though they might meet the technical specifications.

In one embodiment, the at least one technical parameter of a component, in particular of a compressor, comprises the energy consumption and/or a pressure-dependent characteristic curve of the power consumption and/or a delivery volume flow, in particular at maximum pressure, and/or a CO₂ emission quantity, in particular per compressed air volume. In particular, a quality value can be calculated based on a CO₂ emission quantity (of a compressor) per (generated) compressed air volume (delivery volume). A CO₂ emission amount may be determined by an energy consumption of a component (of a compressor) and a, preferably (from a user) predetermined or (from a power plant operator) received (current) value indicating an emitted CO₂ emission amount per provided (electric) energy unit (e.g. kWh). In this respect, an additional indication, in particular concerning the CO₂ emitted during the generation of the required drive power of a compressor, may be required for the indication of a CO₂ emission quantity as a technical parameter. In particular, the CO₂ footprint per compressed air volume (e.g., m³) can be another technical parameter indicating how much CO₂ is emitted during the generation of a compressed air volume by a specific compressor.

In one embodiment, at least one economic parameter of the respective component is assigned to each component in addition to the at least one technical parameter, wherein the economic parameter indicates in particular investment costs and/or maintenance costs of the component, wherein the at least one quality value is calculated in particular based on the at least one technical parameter and at least one economic parameter of at least one compressor of the respective compressed air system configuration. Preferably, the quality value is calculated based on at least one technical parameter of several (all) compressors and/or based on at least one economic parameter of several (all) compressors of the respective compressed air system configuration. In particular, a first quality value is calculated based on at least one technical parameter and at least one economic parameter of the compressors of the first compressed air system configuration and/or, in particular, a second quality value is calculated based on at least one technical parameter and at least one economic parameter of the compressors of the second compressed air system configuration.

In one embodiment, the compressor list includes at least one compressor of an existing compressed air system and at least one compressor that is not installed in the existing compressed air system. By adding one or more compressors of a (real) existing compressed air system to the compressor list or by including them in the compressor list created based on a product portfolio, compressors that are already installed (in reality) can also be mapped in the branched data structure. In this way, the existing compressors of the compressed air system become part of the solution space for the searched design configuration. In particular, it is possible that a compressed air system configuration that does not contain one or more existing compressors is evaluated better than the existing compressed air system configuration based on the quality value. In this way, the method can implement the modification of an existing compressed air system, namely the removal or replacement of an installed compressor. For example, the required compressed air delivery rate may have decreased and removing a compressor may be economical. Since the installation of the existing compressed air system, more powerful and/or more efficient compressors might be available in the product portfolio in the meantime, which improve the quality of the existing compressed air system configuration with regard to the quality criterion and should accordingly be installed instead of an existing compressor.

In one embodiment, generating the branched data structure further comprises: generating, in a memory, a compressor parent node data structure at the highest node level based on component data of at least one compressor of an existing compressed air system. In particular, the highest node level is assigned to exactly one parent node data structure, which in particular corresponds to the origin node (root) of the branched data structure (tree). In this way, an existing compressed air system configuration can be mapped as an output configuration in the branched data structure, namely by a compressor parent node data structure at the highest node level (root node) that contains (some or all of) the compressors of the output configuration. In this case, the at least one compressor of the initial configuration would be included in each compressed air configuration considered. The design of a compressed air system in the form of an extension by adding a compressor can thus be easily implemented.

In a variant of this embodiment, in which an existing compressed air system is mapped as the initial configuration in the branched data structure (by the root node), the compressor list can contain the compressor of the existing compressed air system, with the assigned technical and/or economic parameter having a negative sign. Alternatively (or additionally), a compressor may be assigned a corresponding identifier (marker) for identification as a (real) compressor of an existing compressed air system. By having a negative sign or such an identifier, the addition of a compressor node data structure for this (real) existing compressor can represent the removal of this compressor. For example, a negative energy consumption would reduce the total energy consumption of the configuration, or a negative investment cost would represent sales revenue for a compressor to be removed. In this way, compressors that are present twice in a compressed air configuration, namely once with a positive and once with a negative sign of a parameter, can be disregarded when calculating the quality value.

In one embodiment, the generation of a compressor parent node data structure and/or a compressor child node data structure is additionally based on component data of components for compressed air preparation, in particular a group of components for compressed air preparation. In particular, a component list is a list of components, preferably a list of groups of components, for compressed air preparation. Components for compressed air preparation are preferably connected in series to a compressor. A group of components for compressed air preparation is in particular intended for arrangement along a compressed air path between the compressed air outlet of a compressor and a compressed air reservoir and comprises, for example, dryers, filters, oil separators or other components. A group of multiple compressed air preparation components may be grouped (modeled) as a (single) surrogate component. By associating additional component data indicating compressed air preparation components with compressor node data structures, a series connection of these compressed air preparation components within the compressed air path defined by the compressor of the compressor node data structures can be mapped in the branched data structure.

In one embodiment, preferably as an alternative to the preceding embodiment, a constraint for a compressed air system configuration specifies a required minimum differential pressure for compensating a pressure loss of at least one component for compressed air preparation, in particular a group of components for compressed air preparation. The required minimum differential pressure can be specified in particular in addition to a required minimum pressure of the compressed air specification. The pressure loss caused by the compressed air preparation can be taken into account via a suitable constraint when finding a suitable compressed air system configuration. As a solution, only those compressed air system configurations can then be considered whose generated minimum pressure is sufficiently high to compensate for the pressure loss of the treatment components, e.g. 0.3 bar, and still provide the minimum pressure required by the consumer.

In one embodiment, generating a branched data structure comprises generating, in a memory, at least one further compressor node data structure at a node level based on component data of a compressor of the compressor list, wherein preferably the type of compressor of the compressor node data structure to be generated differs from the type of compressors of the already generated compressor node data structures of this node level assigned to the same compressor parent node data structure. In this way, the branched data structure (tree) can be increased in width. From one or more (lower) node level(s), compressor child node data structures with respect to a compressor parent node data structure are added, preferably in a recursive loop, in particular until a termination criterion is met. At a (higher) node level of a compressor parent node data structure already shown, further compressor parent node data structures are added, preferably in a recursive loop, in particular until a termination criterion is met. This is especially true if there is no single compressor parent node data structure at the highest node level (root node). In particular, for a selection of compressors or all compressors of the compressor list, further compressor node data structures can be generated until no more new compressor node data structures can be generated. Based on certain criteria, which are checked in particular on the basis of a quality value, preferably on the basis of a minimum branch cost value, the generation of certain compressor child node data structures or compressor parent node data structures can be prevented. In principle, component child node data structures based on components other than compressors could also be added to the branched data structure to represent their interconnection within a compressed air system.

In one embodiment, compressor parent node data structures based on component data of the same compressor of the compressor list (i.e. of the same type) are generated multiple times in a node level, wherein for each of the multiple compressor parent node data structures a component child node data structure is generated and assigned to one of the multiple compressor parent node data structures, wherein the types of the components of the component child node data structures differ from each other. In this way, a branched data structure (a tree) can be generated in which different compressed air system configurations for the same compressor are mapped in series with different components, such as different variants of a compressed air preparation component. For example, a particular compressor can be mapped in this way in two different series circuits with different compressed air dryers in each case in the branched data structure (in the tree).

In one embodiment, the compressors of a compressor list are ordered according to a sorting criterion, wherein the component data of compressors which are sorted in the compressor list at the same or subordinate list position as the compressor of the compressor parent node data structure are used to generate a compressor child node data structure which is assigned to a compressor parent node data structure. This helps to avoid permutations among the considered compressed air configurations, i.e. equivalent compressed air configurations in which the same compressor types are connected in parallel with each other, but in different arrangements of the parallel compressed air paths with respect to each other. The interchange of the compressed air paths of two parallel connected compressors within the branched data structure represents an identical compressed air configuration and therefore does not have to be considered more than once. An unnecessary enlargement of the branched data structure can be avoided and computing time can be saved.

In one embodiment, the quality criterion is a cost criterion, wherein the at least one quality value indicates the energy costs and/or investment costs and/or maintenance costs of a compressed air system configuration. The energy costs and maintenance costs may be related to a certain operating time, preferably specified by a user. The investment costs may include the installation costs for a compressed air system configuration in addition to the price of the components. In particular, the most favorable compressed air system configurations, preferably the most favorable (optimal) compressed air system configuration, can be developed based on a cost criterion.

In one embodiment, the method further comprises comparing two compressed air system configurations based on assigned quality values by a computer and storing the compressed air system configuration data of the compressed air system configuration whose assigned quality value better fulfills the quality criterion as the current best compressed air system configuration, and preferably storing the quality value assigned to the current best compressed air system configuration as the current best quality value. The current best quality value indicates in particular the current best, preferably the lowest, costs. The current best compressed air system configuration may change continuously, in particular while the branched data structure is searched for a suitable compressed air system configuration. A variable for the current best compressed air system configuration is initialized in particular with the first found compressed air system configuration or an initial configuration. In particular, the currently best compressed air system configuration found is stored temporarily in order to be compared with other compressed air system configurations considered that are potentially even better with regard to the quality criterion. Preferably, the compressed air system configuration stored last, i.e. at the end of the process, is the optimum solution for the design of the compressed air system.

In one embodiment, calculating the at least one quality value comprises calculating a minimum configuration cost value that indicates, preferably based on an estimation, a lower bound value for the cost of the compressed air system configuration. A lower bound value as a minimum configuration cost value can be understood as a (conservative) estimate of the cost that is certain to be lower than the (relatively accurately) calculated cost of a compressed air system configuration, preferably based on heuristic methods. The minimum configuration cost value is preferably based on energy costs and/or investment costs of at least one of the, preferably all, components of the compressed air system configuration.

The energy costs can be predefined as a technical parameter of a component (a compressor), in particular as part of the received component data. The energy costs are preferably calculated based on the energy consumption of the compressor with the highest energy efficiency of a compressor included in the compressed air system configuration. The investment cost may be predetermined as an economic parameter of a component (a compressor), in particular as part of the received component data. Preferably, the investment cost is calculated as the sum of the investment costs of the compressors included in the compressed air system configuration. In particular, the minimum configuration cost value gives a conservative estimate of the cost of a compressed air System configuration. In particular, no (complex) simulation of the compressed air system configuration is performed to calculate the minimum configuration cost value. The calculation of a minimum configuration cost value is based on the idea that the performance of a more accurate, but in terms of computer power expensive, calculation can be dispensed with if already a conservative cost estimate—i.e. an estimated cost value that is in any case lower than the actual costs—is worse (higher) than the quality value of the currently best known compressed air configuration (i.e. the currently cheapest known cost value). In particular, the performance of a cost-intensive computer simulation can be dispensed with if the minimum configuration cost value is worse than the current best quality value with respect to the quality criterion.

In one embodiment, the calculation of the at least one quality value of a compressed air system configuration comprises the calculation of a minimum branch cost value which, preferably based on an estimation, specifies a lower bound value for the costs of those further compressed air system configurations, in particular those not (yet) represented by node data structures in the branched data structure, which contain the compressors of the compressed air system configuration. Those further compressed air system configurations which contain the compressors of the (currently considered) compressed air system configuration are in particular (all) those further compressed air system configurations which are not (yet) represented by node data structures in the branched data structure (i.e. compressed air system configurations which have not been considered so far but which are possible in principle) whose compressor node data structures are located at lower node levels relative to the node level of that compressor node data structure which corresponds to the (currently considered) compressed air system configuration. A lower bound value as a minimum branch cost value can be understood as a (conservative) estimate of the cost that is certain to be lower than the (relatively accurate) calculated cost of all compressed air system configurations of a branch of the branched data structure, preferably based on heuristic methods. The minimum branch cost value is preferably based on energy costs of a compressor of the compressor list and/or investment costs of at least one of, preferably all, components of the compressed air system configuration. The energy costs are preferably calculated based on the energy consumption of the compressor with the highest energy efficiency of all compressors included in the compressor list (not only in the considered compressed air system configuration). The investment costs are preferably calculated as the sum of the investment costs of the compressors included in the compressed air system configuration. In particular, the minimum branch cost value gives a conservative estimate of the costs of those compressed air system configurations that belong to the branch of the branched data structure (tree) that starts at the node of the currently considered compressed air system configuration. In particular, the minimum branch cost value gives a lower bound value on the cost of all compressed air system configurations directly or indirectly assigned to a parent node that could potentially still be generated. In particular, no (time-consuming) simulation of the compressed air system configuration is performed to calculate the minimum configuration cost value. The calculation of a minimum branch cost. value is based on the idea that further branching of the data structure can be omitted if already a conservative cost estimate—i.e., an estimated cost value that is in any case lower than the actual cost—is worse (higher) than the quality value of the current best known compressed air configuration (i.e., the current cheapest known cost value). This is because adding additional node data structures that represent components actually added to the compressed air system would increase the cost of the corresponding compressed air system configuration. The generation of further child node data structures can be prevented at an early stage if the minimum branch cost value assigned to a parent node data structure is worse than the current best quality value with regard to the quality criterion.

In one embodiment, based on a quality value assigned to a compressed air system configuration, preferably based on the minimum branch cost value, the generation of further compressor child node data structures of a compressor parent node data structure is excluded or compressor child node data structures of a compressor parent node data structure that have already been generated are deleted, especially if the quality value, preferably the minimum branch cost value, fulfills the quality criterion worse than a stored current best quality value, which is assigned to a current best compressed air system configuration. This procedure corresponds in particular to the so-called bounding of a branch-and-bound procedure. Further compressor child node data structures are not generated or deleted if the minimum branch cost value is higher than the current best quality value. The current best quality value can be a simulated cost value calculated by a simulation. As a result of bounding, an unnecessary enlargement or branching of the branched data structure (tree) can be avoided. The number of compressed air configurations to be tested is thus limited. This saves computing capacity for unnecessarily considered compressed air configurations. The procedure is thus accelerated without excluding the finding of a better (optimal) solution.

In one embodiment, calculating a quality value comprises performing a computer simulation and calculating a simulated cost value based on results of the computer simulation, wherein the simulated cost value indicates costs of the compressed air system configuration over a certain (predetermined) operating period. In particular, the certain operating period is specified by a user (simulation horizon). For example, the operating period may comprise a simulated period of seven days and preferably extrapolated to a period of one year. The computer simulation is based, in particular, on a simulation model of the compressed air system configuration that maps a dynamic behavior of the compressed air system configuration, wherein the simulation model preferably takes into account a time-varying compressed air consumption profile (for a configuration consisting of compressors) or counterpressure profile (for a configuration consisting of blowers) as a boundary condition, preferably specified by a user, and/or maps a dynamic operating behavior of at least one compressor of the compressed air system configuration and/or maps the control behavior of a central control system of the compressed air system, in particular an integrated control system. The simulation model is based in particular on a set of several (time-dependent), preferably partial, differential equations which are solved in particular by numerical integration methods (iteratively), in particular integrated stepwise (by means of predetermined time step widths) over time. A compressed air consumption profile indicates in particular the quantity of compressed air made available to a consumer over time (quantity profile over time). A compressed air consumption profile is typically specified for compressors. A counterpressure profile is typically specified for blowers, which can also be understood as compressors in the sense of the invention. An integrated control system is understood to mean the control methods described in WO 2010/072808 A2 and WO 2010/072803 A1, the description of which is incorporated by reference in the present application. A computer simulation allows a very accurate calculation of the cost of a compressed air system configuration as it would be incurred during operation of the compressed air system. In particular, the simulated cost value indicates the energy costs and/or maintenance costs of the compressed air system configuration. The computer simulation is relatively expensive in terms of computing capacity and computing time, especially compared to the generation of the branched data structure and the calculation of a minimum configuration cost. value or a minimum branch cost value, which are determined by a (much) simpler calculation.

In one embodiment, the method comprises storing at least one compressed air system configuration in a simulation waiting list that specifies compressed air system configurations intended for performing a computer simulation. In particular, compressed air system configurations whose minimum configuration cost value is less than the current best quality value are temporarily stored in a simulation waiting list. By performing a computationally intensive computer simulation only for the limited number of compressed air system configurations in the simulation waiting list, computing resources are used only for the most promising compressed air system configurations. As a result, a suitable, preferably the optimal, design configuration can be found in a relatively short time even for complex and accurate simulation models.

In one embodiment, computer simulations for different compressed air system configurations are performed in parallel, in particular by different processors or by different groups of processors, preferably at least partially simultaneously. Preferably, the compressed air system configurations held in a simulation waiting list for simulation are simulated independently of each other by different processors. While the generation of the branched data structure (tree) cannot be parallelized, or can only be parallelized with difficulty, the compressed air system configurations found by the branched data structure can be simulated independently of each other. The computer simulations generally place significantly higher demands on the computing capacities than the construction of the branched data structure. By parallelizing the computer simulations, the process can be significantly accelerated compared to performing the computer simulations sequentially for suitable discovered compressed air system configurations.

In one embodiment, at least one step for generating the branched data structure and the computer simulation for a compressed air system configuration are performed at least partially simultaneously. In particular, an algorithm for generating the branched data structure and the computer simulations for the compressed air system configurations found by the algorithm run in parallel.

In one embodiment, the method comprises pausing steps for generating the branched data structure if the number of compressed air system configurations in the simulation waiting list reaches a predetermined maximum number, in particular until the number of compressed air system configurations in the simulation waiting list reaches a value below the maximum number. This can prevent a computer simulation from being performed for an unnecessarily large number of (relatively poor) compressed air system configurations. By limiting the length of the simulation waiting list, cost values simulated by the computer simulation that potentially indicate a new current best compressed air system configuration can be taken into account when generating the branched data structure. In particular, by comparing the simulated cost values to the minimum branch cost values for considered compressed air system configurations, a branch of the second data structure can be optionally truncated early, thereby preventing the inclusion of one or more worse compressed air system configurations in the simulation waiting list in a timely manner. The method thus saves computing resources and is accelerated.

In one embodiment, providing at least one compressed air system configuration is outputting the, preferably optimal, compressed air system configuration, wherein in particular its assigned quality value, preferably its assigned simulated cost value, satisfies the quality criterion better than the quality values of all other compressed air system configurations that can be generated based on the compressor list. In this respect, the method according to the invention solves an optimization problem.

The aforementioned object is further solved in particular by a computer-readable storage medium with instructions which, when executed on at least one computing unit, implement at least some, preferably all, steps of the method according to the invention. The computer-readable storage medium according to the invention has advantages similar to those already described in connection with the method according to the invention. In particular, the storage medium can be part of the notebook computer of a user, for example a field worker of a provider of compressed air systems or a server of a provider of compressed air systems.

The aforementioned object is further solved in particular by a server comprising a computer-readable storage medium according to the invention and at least one computing unit for executing instructions.

The aforementioned object is further particularly solved by a terminal device that is adapted to send component data to a server, preferably a server according to claim 26, wherein the component data indicate components of a compressed air system and at least one technical parameter of each component, wherein the component data comprise at least one component list with a plurality of functionally identical components of different types and at least one technical parameter assigned to the respective component, wherein a component list is a compressor list containing several compressors of different types, wherein the terminal device is in particular further adapted to send constraint data indicating at least one constraint for a compressed air system, preferably a constraint according to a previously described embodiment of the method, to a server, preferably a server according to the invention, and/or in particular to send a desired compressed air consumption profile for a compressed air system to a server, preferably a server according to the invention, and/or in particular to display at least one compressed air system configuration, preferably with an assigned quality value.

Exemplary embodiments of the invention are explained in more detail below with reference to the drawings, wherein:

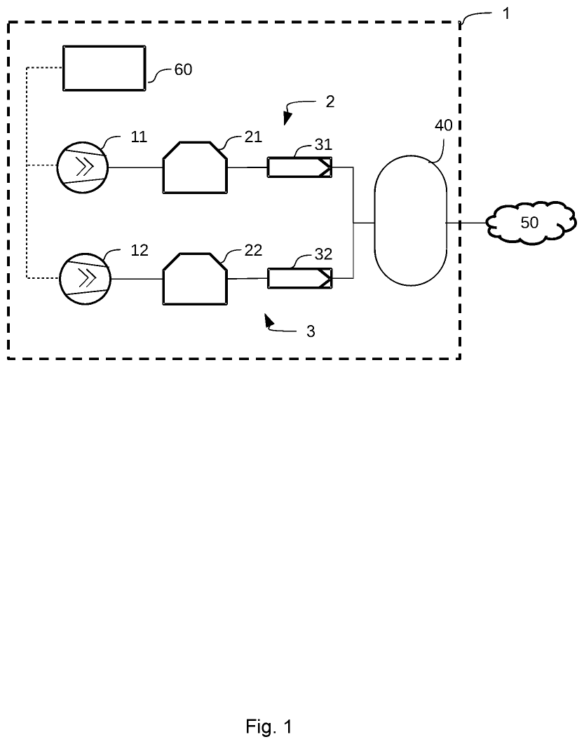

FIG. 1 shows a schematic representation of a compressed air system;

FIG. 2 shows a prior art method for designing a compressed air system;

FIG. 3 shows a general schematic representation of the sequence of the method according to the invention;

FIG. 4 shows a schematic representation of the solution space for compressed air system configurations according to the method of the invention;

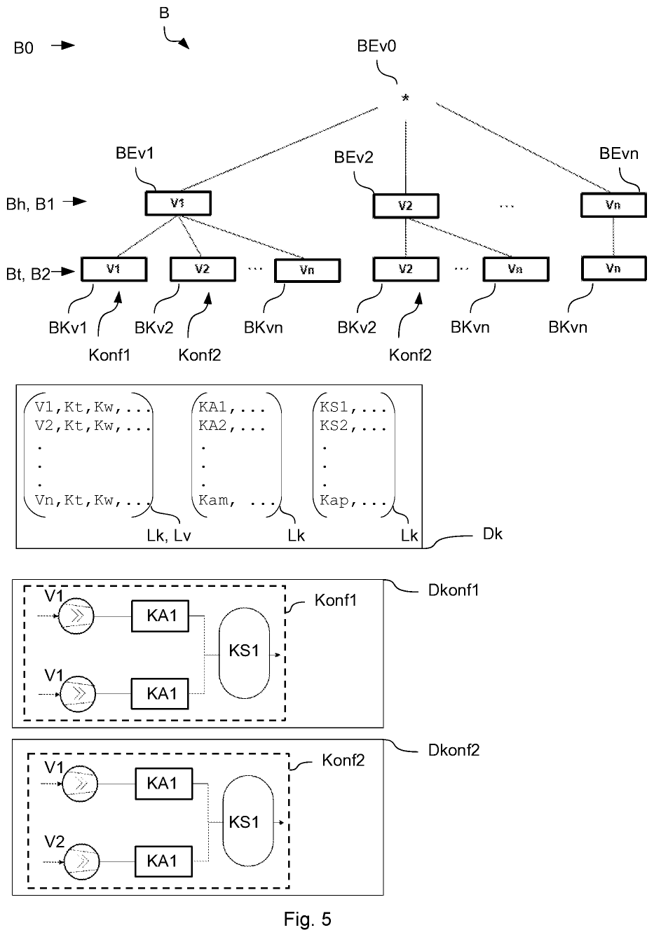

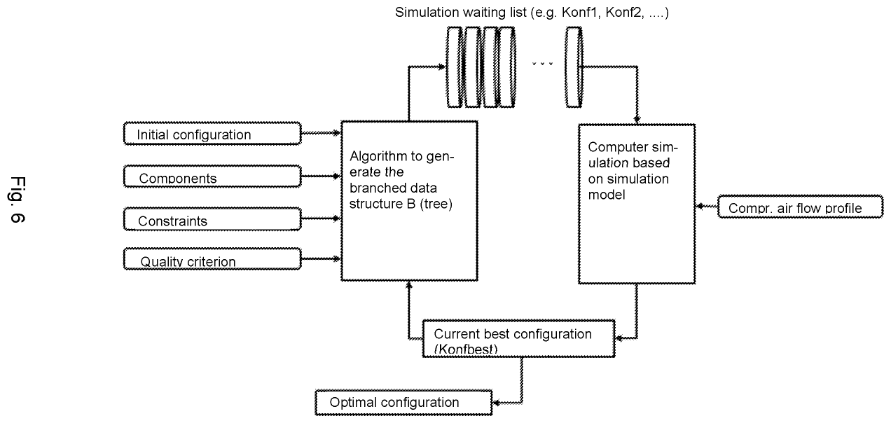

FIG. 5 shows a schematic representation of a branched data structure, the component data and the compressed air system configuration data according to one embodiment of the method of the invention;

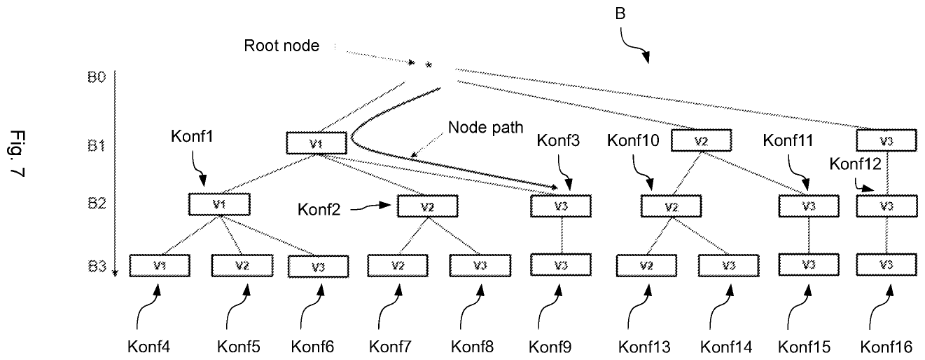

FIG. 6 shows a schematic representation of a sequence of the method according to the invention for finding an optimal compressed air system configuration;

FIG. 7 shows a schematic representation of an exemplary branched data structure (tree) as part of the invention;

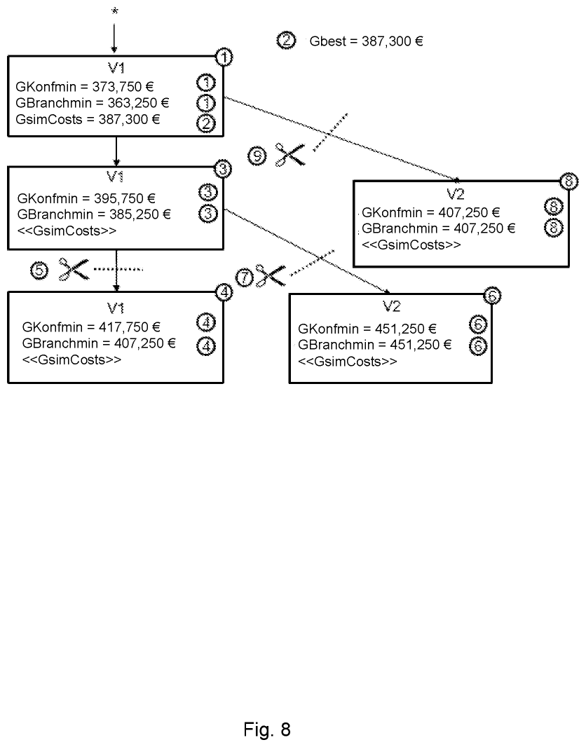

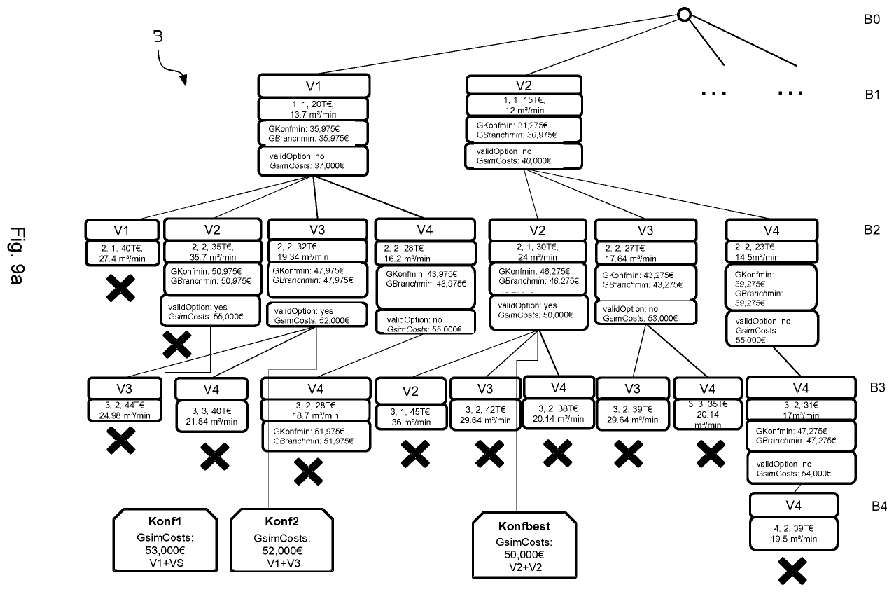

FIG. 8 shows a schematic illustration of an exemplary sequence for generating a branched data structure as part of the invention;

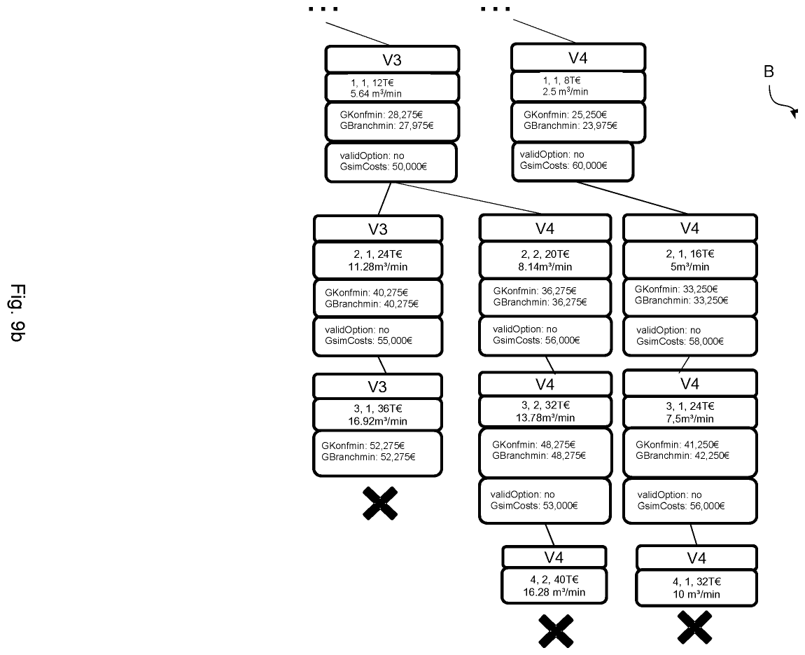

FIG. 9a shows a first part of a detailed schematic representation of an exemplary branched data structure (tree) as part of the invention;

FIG. 9b shows a second part of the illustration of an exemplary branched data structure according to FIG. 9a;

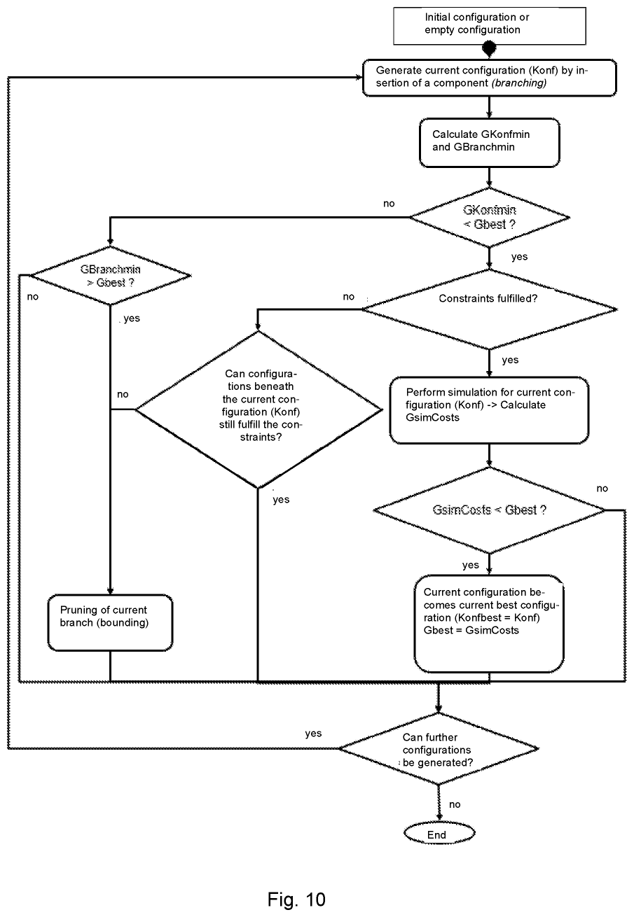

FIG. 10 shows a schematic flowchart of the generation of a branched data structure as part of the invention;

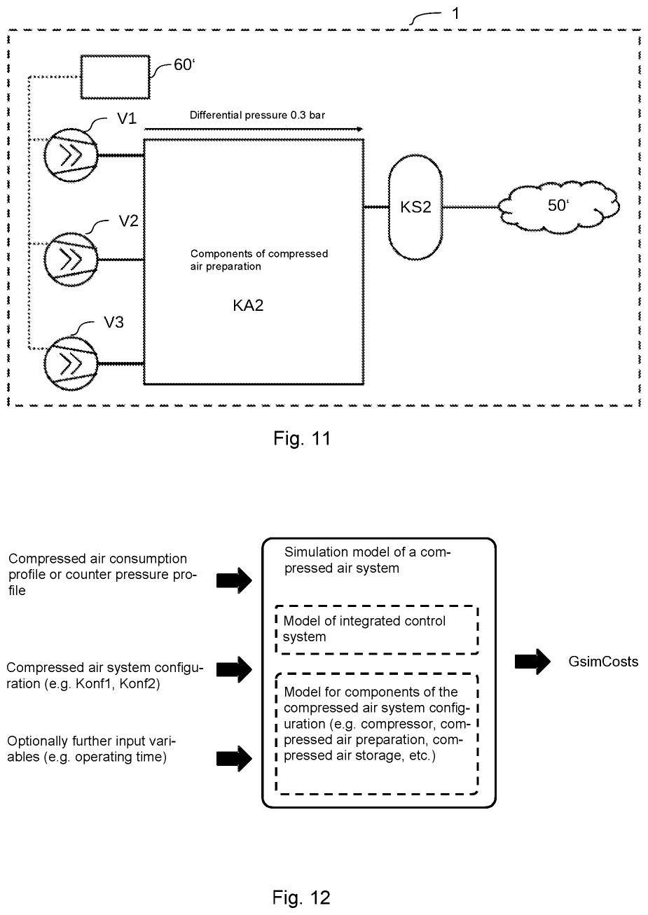

FIG. 11 shows a schematic representation of a simulation model of a compressed air system;

FIG. 12 shows a schematic representation of a simulation as part of the method according to the invention.

In the following description of the invention, the same reference signs are used for the same and similarly acting elements and method steps.

Compressed air systems (compressed air stations) are built up by a large number of different components, which are arranged and interconnected or connected with each other in a defined manner. The components are those for compressed air generation, compressed air preparation, compressed air storage and compressed air distribution. Certain components have their own control systems. Often, compressed air systems have higher-level control systems for the entire plant.

FIG. 1 shows a schematic diagram of a compressed air system 1, which has two parallel compressed air paths 2 and 3. The two parallel compressed air paths 2, 3 have compressor 11, dryer 21 and filter 31 as well as compressor 12, dryer 22 and filter 32. Dryers 21, 22 and filters 31, 32 are each located downstream of compressors 11, 12. Both compressed air paths 2, 3 open into a common compressed air tank 40, which serves to store compressed air. From the compressed air tank 40, compressed air is distributed to one or more consumers 50 via a compressed air network. The compressors 11, 12 of the compressed air system 1 are regulated by a central control system 60.

A compressed air system configuration specifies the set of components of a compressed air system and their interconnection (arrangement and connection of the components relative to each other). Whenever a “configuration” is referred to in the following or a figure refers to a “configuration”, a compressed air system configuration, i.e. a configuration of a compressed air system, is always meant. In this respect, FIG. 1 shows a specific real compressed air system configuration that was selected when designing the real existing compressed air system 1.

Compressed air systems must be designed according to the user's needs. For the design of a compressed air station, i.e. the new planning, modification (removal or replacement of components) or expansion of the compressed air system, a large number of different components are typically considered, which one or various manufacturers offer in their product portfolio. The design must meet a certain quality criterion, for example, in economic terms, the life cycle costs or the so-called “return on investment”, and in technical terms, a compressed air consumption profile specified or assumed by the user. It is the object of the design to find a compressed air configuration (design configuration) that fulfills the quality criterion.

Key influencing factors that are typically taken into account in the quality criterion are energy costs, maintenance costs and investment costs, wherein energy costs and maintenance costs differ from investment costs in that investment costs can be determined solely by analyzing the configuration itself, whereas the dynamic behavior of the components in the specific configuration must always be determined in order to determine energy costs and maintenance costs. Based on the dynamic behavior of the components in the concrete configuration, the energy costs and maintenance costs can then be inferred.

FIG. 2 shows a method for manually determining a prior art compressed air station configuration. Although the method according to FIG. 2 is partly computer-aided with regard to simulation, it is basically manual. A user or operator thinks up a configuration. For this, he draws on a product portfolio of components, as in a catalog, and takes into account any constraints that may be present. Based on the thought-up configuration, the user manually creates a simulation model with the help of simulation software. A simulation is then carried out on the basis of the simulation model. The execution of the simulation itself is done automatically. Once the simulation is performed, the configuration is evaluated based on the simulation result. In particular, the values required for the evaluation are determined from the simulation result. If the configuration is interesting as a possible solution for the design, the user notes this configuration. Then, the user checks if there is a sufficiently good solution among the already remembered configurations. If this is not the case, the user checks if he still has an idea for another configuration that could be a sufficiently good solution. If the user still has such an idea, the method goes to the next iteration, in which a concrete configuration is thought up. If the user has no idea, the method ends. If there is already a sufficiently good solution among the remembered configurations, the user can end the method and use this configuration to design the compressed air system.

The method carried out according to FIG. 2 provides for the creation, simulation and evaluation of several configurations. In this context, the thinking up of configurations and manual creation of the simulation model by a human is a limitation for finding suitable configurations. Thinking up configurations according to the method of FIG. 2 is a creative process. The duration and outcome of this process depend largely on the experience of the user, because in the creative process the user relies on heuristics, i.e. experiential knowledge, that he has acquired. An experienced user will tend to determine better configurations in less time. However, there is no guarantee that even an experienced user will find the best possible configuration.

In addition, the devised configurations must be made available to the simulation software before the simulation is carried out. This is because the quality of a configuration can only be reliably evaluated after a simulation has been carried out. Creating a configuration model for the simulation takes time. If one calculates only 3 minutes for the input of a configuration, one cannot test more than 20 configurations per hour. In limited time, only a limited number of configurations can be checked. It is possible that there is not enough time to find the best possible configuration.

Using a calculation example, it is explained that the number of possible configurations increases rapidly, i.e. exponentially, with the number of components in a compressed air system and with the number of components available in a product portfolio. For the sake of simplicity, only the compressors of a compressed air system are considered below. For example, the product portfolio contains various types of compressors. Assuming that up to eight compressors can be installed in a compressed air system, and neglecting permutation, the following number of possible combinations

$${\sum }_{i = 1}^{8} {20}^{i} = {20}^{1} + {20}^{2} + {20}^{3} + … + {20}^{3} = 26.947 \text{.368} \text{.420} = 2.695 * {10}^{10}$$

are obtained, i.e. possible potential configurations with eight compressors connected in parallel in a compressed air system. With the prior art method shown in FIG. 2, the problem is that the entire solution space cannot be systematically searched for the best configuration due to the large number of possibilities. In addition, the prior art method does not ensure that the optimal configuration is actually found.

Starting from this problem, the present invention is based on the realization that the design of a compressed air system is an optimization problem, the solution of which is the optimal configuration of the compressed air system under the available components and given conditions. FIG. 3 shows a general schematic representation of the flow of a computer-assisted method of the present invention for finding the optimal solution for the configuration of a compressed air system. The optimization problem illustrated in FIG. 3 consists of identifying and providing suitable compressed air system configurations, in particular the optimum compressed air system configuration, on the basis of a given initial configuration of an existing compressed air system and with components of a compressed air system available in a product portfolio, in particular compressors V1, v2, . . . . Vn (see Figs., 2, 7, 8, 9a, 9b), for a given compressed air consumption curve, taking into account predetermined constraints on the basis of a predetermined quality criterion. The method according to the invention for providing at least one design configuration of a compressed air system solves the problem outlined in FIG. 3.

In the method according to FIG. 3, an initial configuration is taken into account. It is possible that an existing compressed air station is to be modified and/or extended, for example because one or more components of the compressed air station have reached the end of their service life and therefore need to be replaced. It is also possible that the efficiency of the compressed air station is to be increased by replacing old components with newer more efficient components. It is also conceivable that the compressed air consumption will foreseeably increase to such an extent that the existing compressed air station can no longer reliably cover it. In such cases, an output configuration must be considered when designing the compressed air station. By modifying or extending the output configuration, new configurations are created that can be considered as (optimal) configurations. If an output configuration is to be considered, it should be noted that no investment costs are incurred for components that are retained in the new configuration with respect to the output configuration. For components that are removed or replaced in the new configuration with respect to the initial configuration, there is basically a negative investment cost, because these components can be sold as used components, generating a return. In the case of replanning, the initial configuration would correspond to an empty configuration, i.e. a configuration without components.

FIG. 4 illustrates how the solution space of possible compressed air configurations can be restricted by the method. The total solution space is defined by all combinatorial possibilities of the available components, in particular by the compressors included in the compressor list Lv (see FIG. 5). The solution space can be restricted by excluding unsuitable configurations, which means that fewer configurations need to be considered as a solution.

Certain configurations may be excluded because they do not meet certain constraints specified by a user (see FIGS. 3 and 6), for example,
a maximum number of compressors,
a maximum number of different types of compressors,
the specification whether variable speed compressors may or must be included,
a maximum footprint of the compressed air system,
a required minimum pressure of the compressed air system and/or.
a required maximum pressure of the compressed air system,
a maximum investment budget.

The solution space can also be restricted by the bounds of a so-called branch-and-bound procedure, which is used for the method according to the invention to build the branched data structure B (see FIGS. 5, 7, 9a, 9b). By lower bounds, for example by a minimum branch cost value GBranchmin (see FIGS. 8, 9a, 9b, 10), configurations can be excluded at an early stage which are certainly worse than the current best configuration Konfbest. (see FIGS. 6, 10) with regard to the quality criterion.

Such configurations, which fulfill the constraints and are mapped by the branch-and-bound procedure in a branched data structure B, are basically considered for a simulation in order to calculate the quality value as accurately as possible with regard to the quality criterion. The simulation can take into account energy costs, maintenance costs, investment costs and a given compressed air consumption profile. Other influencing factors, such as heat recovery from the compressed air system, can also be taken into account.

From the simulated configurations, one or more configurations result as the best solutions on the basis of the determined quality values GsimCosts (see FIGS. 8, 9a, 9b, 10, 12). The configuration with the best overall quality value GsimCosts of all the configurations considered is the optimum solution to the optimization problem, according to which the compressed air system should be designed.

The generation of a branched data structure B as part of the present invention is explained with reference to FIG. 5. Exemplary data structures B are also shown in FIGS. 7, 8, 9a and 9b. FIG. 10 contains a flow chart for the generation of a branched data structure B. The method according to the invention is based on the idea of conceiving the available components from a product portfolio as component lists Lk of functionally identical components whose list elements can be combined with each other in all combinatorial ways to form a compressed air system configuration. The component lists Lk contain technical and economic properties, in particular technical parameters Kt and economic parameters Kw of the respective components. In principle, components of a component list Lk can be considered as available as often as desired for the generation of configurations. A component from a component list L.k can therefore be incorporated several times in a configuration. Systematically trying through all possibilities would also consider the optimal solution, but is not practically feasible due to the large number of possibilities. The method according to the invention therefore uses a branched data structure B in order to be able to systematically run through the configurations (number N) Konf1, Konf2, . . . , KonfN which can be considered in principle. Such branched data structures B are in principle known as trees, which are created by an algorithm. According to the invention, a branch-and-bound procedure is used to generate the branched data structure B.

The components available in a supplier's product portfolio for the design of a compressed air system are available in the form of component data Dk, with functionally identical components grouped together in component lists Lk. The n different compressors V1, V2 to Vn are contained in a compressor list Lv according to a sorting criterion. The m different components for compressed air preparation KA1, KA2 to KAm and the p different. components for compressed air storage KS1, KS2, to KSp are each contained in a component list I.k. Based on the component data Dk, a branched data structure B is generated according to the invention, which indicates possible combinations of the components.

FIG. 5 illustrates an embodiment of a branched data structure B as a component of the method according to the invention. By way of example, three node levels B0, B1, B2 are assigned a plurality of node data structures, wherein the highest node level B0 is assigned only a single compressor node data structure BEV0, the first node level B1 is assigned the compressor parent node data structures BEv1, BEv2, to BEvn, and the second node level B2 is assigned the compressor child node data structures BKv1, BKv2, . . . , Bkvn. Each compressor child node data structure at a relatively lower node level Bt is assigned to a parent node data structure at a relatively higher node level Bh. With respect to node level B1, B0 represents the higher node level Bh. With respect to node level B2, B1 represents the higher node level Bh. Branching may occur from a higher node level Bh to a lower node level Bt, such that the number of compressor node data structures may be greater at the lower node level Bt. In the present example, the compressor parent node data structure BEV0 corresponds to an empty output configuration of a compressed air system and, in this respect, is a node data structure that does not contain any compressors. If an output configuration exists, it could be represented by the compressor parent node data structure BEv0. The branched data structure B is built by a recursive loop, generating compressor node data structures until a termination criterion is met.

Each of the compressor parent node data structures BEv1, BEv2 to BEvn represents one of the compressors V1, V2 to Vn contained in the compressor list Lv, which is one of the component lists Lk. Compressors V1, V2 to Vn each have a unique compressor type that are different from each other. At least one technical parameter Kt and one economic parameter Kw are assigned to each compressor V1, V2 to Vn, and the compressor list Lv may contain further information on each compressor V1, V2 to Vn. In the branched data structure B, each compressor node data structure represents a particular compressed air system configuration. The respective compressed air system configuration comprises the compressors of the node data structures located along the node path (see FIG. 7) from the respective node data structure to the next higher one via all higher node levels upwards to the highest node level B0.

In FIG. 5, an exemplary first compressed air system configuration Konf1 comprises compressor parent node data structure BEv1. and assigned compressor child node data structure BKv1, each representing a compressor of type V1. An exemplary second compressed air system configuration Konf2 comprises compressor parent node data structure BEv1 and assigned compressor child node data structure BKv2, each representing a type V1 compressor and a type V2 compressor, respectively. An alternative exemplary second compressed air system configuration Konf2 in FIG. 5 consists of the compressor parent node data structure BEv2 and the assigned compressor child node data structure BKv2, each representing a compressor of type V2. FIG. 5 thus illustrates the generation of a first compressed air system configuration Konf1 according to the invention as well as both alternatives for the generation of a second compressed air system configuration Konf2. The designation of a specific compressed air system configuration of the compressed air system configurations 1 to N shown in the branched data structure B as Konf1, Konf2, . . . , KonfN is arbitrary.

In the compressed air system configurations Konf1, Konf2 shown in FIG. 5, the compressors V1, V1 and V1, V2 are each connected in parallel. The component for compressed air preparation KA1 connected in series with each compressor is the same in each case, as is the component for compressed air storage KS1 to which the two parallel compressed air paths are combined. Compressed air system configuration data Dkonf1, Dkonf2 clearly indicate the components and their interconnection. The compressed air system configuration data Dkonf2 shown refer to the compressed air system configuration Konf2 “V1, V2” with compressors V1 and V2 (in FIG. 5, on the left). Compressed air system configuration data of the alternative compressed air system configuration Konf2 “V2, V2” (in FIG. 5, on the right) would analogously comprise two compressors of type V2 connected in parallel.

With the help of the branched tree structure B, the entire solution space can in principle be searched systematically and automatically with computer support. All basically suitable configurations, which fulfill the constraints, for example, the best configurations which fulfill a given quality criterion well, and the (only) optimal configuration which best fulfills the quality criterion, are contained in the branched tree structure B and can be found.

The present invention provides a method that finds the best compressed air system configurations and calculates assigned quality values in a fully automated manner. Compared to the prior art shown in FIG. 2, the method in particular performs the automation of the determination of new configurations, the creation of the configurations for the evaluation of the quality, the verification whether a configuration is a suitable solution and the recognition that the optimal configuration has been found, if it exists. In particular, the result of the method does not depend on the experience of the user. In addition, the computer-implemented method is relatively fast to perform. By creating a branched data structure B according to the idea of a branch-and-bound procedure, the solution space to be searched is restricted, i.e., the branched tree structure is “pruned” in a suitable way, so that the procedure quickly yields desired design configurations even with limited computing capacities.

FIG. 6 shows the basic procedure of the method according to the invention for finding an optimum compressed air system configuration. As already explained with regard to FIG. 3, starting from an initial configuration based on component data Dk of the available components, in particular a compressor list Lv, the predetermined constraints and the predetermined quality criterion, suitable configurations (e.g. Konf1, Konf2) are determined with the aid of an algorithm for generating a branched data structure B (see e.g. FIG. 5), which are considered for a simulation and are stored in a simulation waiting list. Simulations considered due to the branched data structure B are included in the simulation waiting list based on a comparison of the minimum configuration cost value GKonfmin with the quality value Gbest of the current best configuration Konfbest, if GKonfmin satisfies the quality criterion better than Gbest. A computer simulation based on a simulation model of a compressed air system (see FIG. 12) determines the simulated cost value GsimCosts as a quality value of the simulated configuration, taking into account a given compressed air profile. Based on GsimCosts, the simulated configuration can be compared with the quality value Gbest of the current best configuration Konfbest. The current best configuration Konfbest stored at the end of the process, whose quality value GsimCosts best fulfills the quality criterion, is the optimum configuration for designing the compressed air system.

One idea of the invention is that the algorithm for building the branched data structure B and computer simulations for configurations identified on the basis of the tree structure B run in parallel in time. Each time a basically suitable configuration is identified, it is stored in a simulation waiting list of configurations to be simulated. The configurations in the simulation waiting list are simulated one after another, preferably in parallel on different computers, and the simulated cost value GsimCosts is calculated as a quality value of this configuration. A simulation waiting list of length 1 results in every configuration suitable for simulation being simulated sequentially. The maximum length of the simulation waiting list can be used to control how many configurations may be generated by the data structure B without using the simulated cost values GsimCosts determined by the simulation for already generated configurations to a most efficient possible constraint of the data structure. If the simulated configuration is stored as the current best configuration Konfbest with assigned quality value Gbest, the simulation result will be used in the generation of the branched data structure B. This is because the algorithm for generating data structure B takes into account, by comparing a minimum branch cost value GBranchmin with Gbest, whether even better configurations than the current best configuration Konfbest can be generated at all by adding further compressor child node data structures to data structure B. If this is not the case, corresponding compressor node data structures are not generated at all.

FIG. 7 shows a schematic representation of an embodiment of a branched data structure B on three node levels B1, B2, B3, i.e. for three compressors connected in parallel. This example concerns the new planning of a compressed air system, wherein the possible configurations for three parallel-connected compressors V1, V2, V3 are considered here and other components of the compressed air system are not taken into account. The root node of the branched data structure B at the node level B0 is empty if no initial configuration is considered. The solution space, i.e. the set of all possible configurations (see FIG. 4), is created by generating compressor node data structures in a recursive loop. Each compressor node data structure is based on the component data Dk of one of the compressors V1, V2, V3 and represents a compressed air system configuration Konf1 to Konf16 consisting of the compressors along the node path from the compressor node data structure to the root node. The depth of the tree, i.e. the number of node levels B1, B2 and 83 can be limited by the number of compressors allowed in a compressed air system as a constraint. In the present case, the maximum number of compressors to be used is specified as three.

Typically, the arrangement sequence of compressors in compressed air systems does not matter, provided that all compressors are arranged in parallel. This fact is taken into account in the branched data structure B by not inserting nodes in the tree that lead to configurations that differ only in the sequence from configurations already present in the tree (in the tree shown above, there is the configuration “V1, V2, V2”, but not the configuration “V2, V1, V2”, because these two configurations are equivalent if the sequence is neglected. By avoiding equivalent configurations, the branched data structure B (the tree) and thus the solution space is kept small.

The construction of the tree for the representation of the solution space can be explained most simply with a recursive algorithm, wherein also iteratively proceeding algorithms for the construction of the tree are conceivable. For the description of the recursive algorithm it is assumed that the product portfolio of components is sorted according to some criterion, e.g. by ascending investment costs, ascending supply volume, by alphabetically ascending type designation, etc. Accordingly, the components can be thought of as ordered component lists Lk, in which each component has a list position. The algorithm starts at the root at node level B0 and adds a child node below the root at the next lower node level B1 for each element from the compactor list. Then the algorithm goes into each child node and adds a new element as a child node in each child node. The rule here for adding new elements as child nodes is that only elements from the sorted list may be added as child nodes that are located at the same position or a subsequent position in the sorted list. For adding child nodes, the constraints are also taken into account. Examples of conditional adding of child nodes are the following:
A child node is added only if the addition of the child node does not exceed the maximum allowable investment cost;
A child node is added only if the addition of the child node does not exceed the maximum number of compressors allowed;
A child node is added only if the addition of the child node does not exceed the maximum allowed number of compressor types.

The process for the recursive addition of child nodes is continued until no more child nodes can be added at any point in the branched data structure B. The nodes of the branched data structure B, coded by the respective node path from or to the root, now form the configurations that span the solution space.

The branched data structure B shown as an example in FIG. 7 represents the following list of 16 configurations Konf1 to Konf16, in each of which two or three compressors are connected in parallel to each other: “V1, V1” (Konf1), “V1, V2” (Konf2), “V1, V3” (Konf3), “V1, V1, V1” (Konf4), “V1, V1, V2” (Konf5), “V1, V1, V3” (Konf6), “V1, V2, V2” (Konf7), “V1, V2, V3” (Konf8), “V1, V3, V3” (Konf9), “V2, V2” (Konf10), “V2, V3” (Konf11), “V3, V3” (Konf12), “V2, V2, V2” (Konf13), “V2, V2, V3” (Konf14), “V2, V3, V3” (Konf15), “V3, V3, V3” (Konf16). The compressor node data structures at the B1 level do not represent valid compressed air configurations because they each have only a single compressor.

In detail, the construction of the data structure B (tree) shown in FIG. 7 proceeds, for example, as follows: in a first step, the component data Dk with the compressor list Lv containing the compressors V1, V2, V3 in the given order are received by a computer. Then, a first compressor data node structure indicating a compressor of type V1 is added to the data structure B starting from the root node at node level B1. At node level B2 below this compressor parent data node structure, another compressor child node data structure of a compressor V1 corresponding to the configuration Konf1 is generated. At node level 83 below this, another three compressor child node data structures with contents V1, V2, and V3, respectively, are generated corresponding to Konf4, Konf5, and Konf6 configurations. More compressor child node data node structures at lower node levels are not added because this would violate the constraint of a maximum of three compressors allowed in a configuration. At node level B2, the compressor node data structures of a compressor of type V2 are generated next, which corresponds to the configuration Konf2. Based on this, at node level B3, further compressor child node data structures are generated for compressors V2 and V3 corresponding to configurations Konf7 and Konf8, respectively, but no compressor child node data structure is generated for a compressor V1, since such a configuration would be equivalent to the configuration Konf5 and would only be a permutation of the compressor combination “V1, V1, V2”. For the same reason, a compressor child node data structure for a compressor V3 is generated next at node level B2 and B3, corresponding to configurations Konf3 and Konf9, respectively, but no other compressor node data structures. The remaining compressor node data structures corresponding to the configurations Konf10, Konf11, Konf12, Konf13, Konf14, Konf15, and Konf16 are generated in an analogous way.

In principle, it is helpful to keep the tree, and thus the solution space to be searched, as small as possible. The user can specify constraints (see FIGS. 3 and 6) to exclude certain solutions. For example, based on heuristics, it may already be known that configurations suitable for the requirements should have certain compressor types. For example, a constraint may specify that at least one variable speed drive compressor must be included in a configuration, or conversely, that a configuration must not have a variable speed drive compressor. A further restriction of the solution space is possible by predefining part of the solution, in particular by not leaving the root node of the data structure empty, but by assigning the root node to a set of compressors that should contain each configuration. All nodes below the compressor parent data structure corresponding to the root node at the node level B0 then extend this already predefined compressor combination.

In principle, it is conceivable for the implementation of the method according to the invention that, in a first step of the method, the complete branched data structure B (tree) for the representation of the solution space is first created and then the best configurations are searched for in the solution space. A preferred embodiment of the method provides for building and searching the solution space in parallel with performing simulations and evaluating configurations. This allows the solution space to be bounded by preventing the creation of node data structures in time, i.e. preventing the branching of the tree, which have not yet been created. It is also possible to delete node data structures afterwards, i.e. to cut off branches of the tree which have already been created but whose configuration has preferably not yet been simulated. This procedure is illustrated in FIG. 8. The method takes into account that the best configuration found so far, i.e. currently, Konfbest, specifies a quality value Gbest, which the quality values of potential configurations in a branch of the data structure B must at least reach in order to be a more suitable, i.e. even better, solution. If it can be excluded that a configuration exists in a branch which is better than the current best configuration Konfbest, the branch can be cut off without risking that an even better solution is not found. Cutting off a branch is symbolically represented by shears in FIG. 8. By cutting off branches, the solution space can be greatly reduced. This speeds up the method considerably and makes it possible to implement it in a practical way at all in the case of very large solution spaces.

As a criterion for a restriction of the data structure B, a conservative estimate is used, which specifies how good the configurations can become from this branch of the data structure (tree). For this, a minimum branch cost value GBranchmin is calculated as a quality value. Further branching is prevented if all configurations potentially found in this branch cannot undercut the current best configuration (GBranchmin >Gbest).

According to a first approach to estimate the quality of the configurations, the energy costs are used as the minimum branch cost value GBranchmin. For the estimation of the lowest possible energy costs in a branch, it is assumed that all compressed air for covering a given compressed air consumption profile is generated with the energetic efficiency of the most efficient compressor that can potentially occur in this branch, i.e. by the compressor that has the highest energy efficiency of all compressors in the compressor list.

According to a second approach, the sum of the energy costs and the investment costs can be formed as the minimum branch cost value GBranchmin, wherein a “break-even node” can be identified which is optimal in terms of costs. From this “break-even node”, the addition of a more efficient compressor or compressors no longer reduces the energy costs to the same extent as the investment costs increase in return. At this node, the branch is cut off.

According to a further developed embodiment of the first approach, an attempt is first made to cover the amount of compressed air to be produced over the entire period under consideration with the most efficient compressor in the branch. For the remaining balance, the second most efficient compressor in the branch is taken. If there is still a remainder, the third most efficient compressor in the branch is taken for this, and so on.

The minimum configuration cost value GKonfmin described earlier, which is used in particular to decide whether or not to perform a computer simulation for a configuration, is calculated based on a similar conservative estimate of the costs as the minimum branch cost value GBranchmin.

The bounding of the data structure is explained in more detail below with reference to FIG. 8. For bounding, a cost estimate GBranchmin is calculated for each compressor node data structure, i.e., for each node, for the entire branch that would result from a bifurcation. The cost estimate GBranchmin indicates the minimum expected cost of the best compressed air system configuration that can be contained from that branching point, i.e., in that branch.

In order to guarantee that the optimal solution is not rejected by the constraint, the cost estimate GBranchmin must be conservative, i.e. GBranchmin must in any case be below the costs that could be determined by a simulation as GsimCosts. If the sum of investment costs and energy costs is used as the quality value GBranchmin, it makes sense to make an estimate of the lowest possible investment costs and an estimate of the lowest possible energy costs for GBranchmin in each case. The sum of these two estimates is then certainly a conservative estimate of the lowest possible value of the costs.

For the estimation of the lowest possible investment costs in a branch, it is assumed that the investment costs of all nodes of the branch are equal to the investment costs of the node where the branch starts. Thus, it is assumed that the investment costs do not increase for the additional child nodes. Although this is a wrong assumption, this estimation is conservative in any case. It certainly does not discard the optimal solution.

For the estimation of the lowest possible energy cost in a branch, it is assumed that the compressed air consumption is covered exclusively by the most efficient compressor included in the compressor list Lv and thus potentially included in the nodes of a branch.

If GBranchmin is above the current best quality value Gbest, which corresponds to the simulated costs GsimCosts of the current best configuration Konfbest, the data structure can be bounded without discarding the optimal solution.

The procedure for branching and bounding the data structure is described below using an example with the following details illustrated in FIG. 8:
Only two types of compressors V1 and V2 are available, viz.
   Type V1,
      Investment costs: 22,000 EUR,.
      Delivery volume flow: 5.5 m³/min,
      Specific power: 6.7 kWmin/m³,
   and type V2,
      Investment costs: 40,000 EUR,
      Delivery volume flow: 10 m³/min,
      Specific power: 6.5 kWmin/m^{3.}
The compressed air system has at least one V1 type compressor.
The required air volume over the lifetime of the compressed air system is 21,000,000 m³.
The price of electricity is 0.15 €/kwh.
There is no limit to the number of compressors in the compressed air system.
The branched data structure B is first built up in depth, only then in width.

Starting from an initial configuration of a compressed air system having at least one compressor (*), a compressed air system is created in step 1 that includes only one additional compressor of type V1. In this case, at least one compressor is already included in the root node (*). For this configuration, a minimum configuration cost value GKonfmin is generated for the compressed air system itself (373,350 EUR) and a minimum cost estimate GBranchmin for the entire branch (363,250 EUR). The fact that the cost estimate for the branch GBranchmin is lower than for the configuration GKonfmin itself is due to the fact that compressed air systems at node levels below the configuration could use the more efficient compressor type V2, while the configuration itself only has the inefficient compressor type V1.

Since no simulation has been performed yet, in step 2 the configuration is simulated and simulated costs GsimCosts of 387,300 EUR are determined for this configuration. These are stored as the current best quality value Gbest, which indicates the current best (lowest) cost of a configuration.

In step 3, a new branch is created by adding a V1 type compressor and the costs for configuration GKonfmin and branch GBranchmin are determined. Since the minimum cost of configuration GKonfmin is higher than the current best cost Gbest, no simulation is performed for this configuration. The computational effort for the simulation is thus saved.

Since the minimum cost GBranchmin of the branch just created is below Gbest, a new branch is created in step 4 by adding another V1 type compressor and the cost of the configuration GKonfmin and the branch GBranchmin is determined. Since the minimum cost of configuration GKonfmin is higher than Gbest, no simulation is performed for this configuration. The computational effort for a simulation is thus saved again.

Since the minimum cost of the branch GBranchmin is also above Gbest, the branch just generated is truncated in step 5 and thus not pursued further.

In step 6, a new branch is created by adding a compressor of type V2 for the configuration that already contains two compressors of type VI and the minimum costs GKonfmin of the configuration and the newly created branch GBranchmin are determined. Due to too high minimum costs GKonfmin of the configuration, no simulation is performed here either.

Since the minimum costs GBranchmin of the newly created branch are also higher than Gbest, the newly created branch is truncated in step 7.

In step 8, a new branch is created by adding a compressor of type V2 to a configuration that already contains a compressor V1, and the minimum costs GKonfmin for the configuration itself and the costs GBranchmin for the newly created branch are determined. Due to a too high minimum configuration cost value GKonfmin, no simulation is performed here.

Since the minimum costs GBranchmin of the newly created branch are also higher than Gbest, the newly created branch is truncated in step 9.

Further configurations and branches are not created, as these can certainly not represent the current best configuration Konfbest with regard to the quality criterion. The method is thus finished and the best solution, namely a compressed air system consisting of only one additional V1 type compressor in addition to the compressors of the initial configuration, is found.

This example clearly shows how the potentially infinitely large solution space is reduced to a manageable level by the method. In total, only five configurations were generated and even only one simulation was performed.

The method according to the invention is explained below with reference to a further example of the construction of a branched data structure B, which is divided between FIGS. 9a and 9b.

As a constraint, the following four compressors V1, V2, V3, V4 are selected from a product portfolio, to each of which a compressed air capacity and an electricity consumption are assigned as technical parameters Kt and an investment volume as economic parameter Kw:

| | Investment | Compressed | Power |
|---|---|---|---|
| | volume in | air output in | consumption in |
| Compressor | euros | m³/min | kW/(m³/min) |
| V4 | 8,000 | 2.50 | 6.9 |
| V3 | 12,000 | 5.64 | 6.51 |
| V2 | 15,000 | 12.00 | 6.51 |
| V4 | 20,000 | 13.70 | 6.93 |

A sorting sequence is selected for the compressors. In the present case, the compressors are sorted in descending order of compressed air capacity, so that the compressor with the highest compressed air capacity is always selected first, then the compressor with the next lowest, and so on.

In a further step, constraints are defined, namely;
the air volume over the compressed air station over the lifetime should be 1 million m³;
the electricity price is assumed to be 0.15 euro/kWh;
the maximum number of compressors should be three;
the maximum number of compressor types used should be two;
the required air volume at the peak should be 19 m³/min;
the maximum investment budget is 36,000 euros.

For the generation of the branched data structure B according to FIGS. 9a, 9b, a depth-first search up to the fourth node level 84 is used for the branch-and-bound procedure. Here, the steps for creating the nodes are given as examples. The further steps for creating the data structure B can be derived from the information in FIGS. 9a, 9b.

In FIGS. 9a, 9b, in addition to the compressor type V1, V2, V3 or V4, further information is given in the first section in the compressor node data structures (simplified also referred to as “nodes”). In a second section, the number of compressors, the number of different compressor types, the investment volume and the compressed air capacity are indicated. In a third section, if present, the minimum configuration cost value GKonfmin for the configuration corresponding to the node and the minimum branch cost value GBranchmin for the branch belonging to this node. In a third section, if present, a parameter validOption is given to indicate whether each is a valid solution, i.e., a suitable configuration, that satisfies the constraints. In addition, the simulated costs GsimCosts are given, which result from a simulation of the configuration.

In a first step, the first compressor V1 is selected. Since this results in a compressed air capacity of only 13.7 m³/min, which is smaller than the required capacity of 19 m³, this selection does not yet represent a valid configuration. In a further step, the minimum cost GKonfmin of the configuration is estimated to be 35,975 euros and the minimum cost GBranchmin of the entire branch is also estimated to be 35,957 euros. In this case, no simulation is performed.

In a further step, the first compressor V1 is added to the configuration “V1” at the second node level B2. Since for the configuration of this node with 40,000 EUR the previously defined maximum permissible investment volume of 36,000 is already exceeded, this configuration and all configurations below it are discarded (indicated in FIGS. 9a and 9b by a cross symbol “X” below the respective discarded configuration). Thus, the branch belonging to this node is cut off. In a further step, the second compressor V2 is added to the configuration “V1” at the second node level B2. It is determined that this is a valid solution (validOption=yes) that satisfies the constraints. Then the configuration is simulated and simulated costs GsimCosts of 55,000 EUR are determined for it, which are stored as best costs Gbest so far.

According to this example, the depth search is now postponed for the time being and the other nodes at the second level 82 are determined first. To do this, the other nodes below the first node “V1” of the first node level B1 are traversed in sequence. The same procedure is repeated for the further nodes of the first node level B1 (see continuation in FIG. 9b). This procedure has the advantage that the simulation results GsimCosts of the valid nodes added in the second node level B2 can already be used to decide whether nodes should still be added in the third and fourth node levels B3, B4.

In the present case, at the third node level B3, the configurations “V1, V3, V3”, “V1, V3, V4”, “V2, V2, V2”, “V2, V2, V3”, “V2, V2, V4”, “V2, V3, V3” and “V2, V3, V4” are discarded because the previously defined maximum investment volume or the maximum number of different compressor types has been exceeded. In this case, the respective assigned branch is also cut off, because the investment volume or the number of used compressor types is exceeded, and these values remain at least the same or even increase by adding compressors.

In contrast, at the third node level B3, for the configurations “V1, V4, V4”, “V2, V4, V4”, “V3, V3, V3”, “V3, V4, V4”, “V4, V4, V4”, it is determined that the supplied compressed air volume is still insufficient. In the case of the configuration “V1, V4, V4” it is determined by simulation that the simulated costs GsimCosts of 51,975 are already above the best costs Gbest of 50,000 Euro, which were determined in the second node level B2. Thus, the branch is cut off here, since adding another compressor can only increase the total cost. In the other cases, the current best cost Gbest of 50,000 is not yet exceeded and additional nodes are added.

However, in the present case, the constraints indicate that the maximum number of compressors is already exceeded by using four compressors. Alternatively, it is also possible to dispense with the creation of nodes in the fourth node level B4, because the maximum permissible number of compressors is then exceeded in any case. In addition, in the present example it results that for the configurations “V3, V3, V3”, “V3, V4, V4” the investment volume is exceeded, while for the configurations “V3, V4, V4”, “V4, V4, V4” the supplied compressed air volume is still not sufficient.

Overall, in the present example, after the complete construction of the branched data structure B, it results that the configuration “V2, V2” consisting of two compressors is the best solution, i.e. the best configuration Konfbest, which at the same time satisfies the constraints and minimizes the costs.

FIG. 10 shows a flow chart for building a tree structure of a branched data structure B. In a first step, an initial configuration is taken as a basis or a new planning is started. In a subsequent so-called “branching step”, a component, in this case a compressor, is inserted, In a further step, the minimum configuration cost value GKonfmin for the currently considered configuration Konf and the minimum branch cost value GBranchmin are determined for the branch belonging to the node of the currently considered configuration Konf. The currently considered configuration Konf corresponds to a currently considered node of the branched data structure B.

In a decision step, it is checked whether the minimum configuration cost value GKonfmin for the currently selected configuration Konf is below the current best costs Gbest for the current best configuration Konfbest. The current best configuration Konfbest is the one that satisfies the constraints and has the best quality value with respect to the quality criterion. If this is the case, a further decision step checks whether the currently selected configuration Konf violates constraints. If this is not the case, then in a further step a simulation is performed for the currently selected configuration Konf. The simulation determines the simulated costs GsimCosts of the configuration and, if necessary, also other key figures, such as properties of the pressure curve or the volume flow.

After the simulation, a further decision step tests whether the simulated costs GsimCosts are better than the costs Gbest of the current best configuration Konfbest. If this is the case, it is saved that the current configuration Konf is the current best configuration Konfbest and the best costs Gbest are set to the simulated costs GsimCosts. If not, the previously determined values for the best configuration Konfbest and the best quality value or the best cost Gbest remain.

Subsequently, it is checked whether further configurations can be generated. For this purpose, those configurations are considered which fulfill the constraints and which have not already been excluded before by the bounding of the data structure B. If no further configurations can be generated, the method ends and the best (optimal) configuration is equal to the stored current best configuration Konfbest. Otherwise, the method jumps back to the above branching step where a node is inserted based on a further component for a compressed air system configuration. The further configuration can be found in particular after a depth search or a width search in the branched data structure B, wherein the method can also switch between a width search and a depth search.

If in the above decision step it is determined that the minimum configuration cost value GKonfmin for the configuration Konf currently under consideration is not below that of the current best costs Gbest of the current best configuration Konfbest, a further decision step checks whether the minimum branch cost value GBranchmin for the branch is above the costs Gbest for the current best configuration Konfbest. If so, the data structure B is bounded, i.e. the branch is pruned. Otherwise, it is checked whether further configurations can be generated. If this is the case, the method jumps back to the above branch step. Otherwise, the method is terminated.

If it is determined in the above step that the considered configuration Konf violates at least one of the constraints and thus does not represent a valid configuration, a further decision step tests whether a configuration branching off from it, which is located at a lower node level, can still fulfill the constraints. This is not the case, for example, if a technical or economic property of the currently considered configuration Konf does not satisfy the constraints and this property can only get worse with increasing number of compressors. If no configuration at a lower node level can satisfy the constraints, then the branch is pruned. Otherwise, a check is made to see if any more configurations can be generated. If this is the case, the method jumps to the branching step above. Otherwise, the method is terminated.

Also after the branch trimming step, a check is made to see whether more configurations can be created. If this is the case, the method loops back to the above branching step. Otherwise, the method is terminated.

FIG. 11 schematically shows an automatically generated simulation model of a compressed air system 1 corresponding to a configuration in which compressors V1, V2, and V3 are connected in parallel (i.e., a “V1, V2, V3” configuration) and are centrally controlled by a model of an integrated control system 60′. The components of the compressed air preparation are modeled by a substitute component KA2, wherein the differential pressure due to the pressure drop across the compressed air preparation is 0.3 bar. This differential pressure can be specified as a minimum differential pressure in the form of a constraint. The compressed air reservoir here has a volume of 10 m³. A consumer 50′ is modeled via a compressed air consumption profile.

For configurations that are well suited with regard to a quality criterion, a computer simulation is carried out in order to be able to better evaluate these configurations on the basis of the simulation result. A simulation shall mean in principle that the behavior of the components of the compressed air station over time, i.e. the dynamic operating behavior, is mapped via a computer model. In a preferred variant of the method according to the invention, a set of differential equations is used for this purpose. In a further developed variant thereof, the set of differential equations is implemented in such a way that the structure-variant behavior of the components, i.e. different behavior in discretely distinguishable operating states, is taken into account.

FIG. 12 illustrates a computer simulation that is carried out to calculate the quality value of the simulated costs GsimCosts as accurately as possible for compressed air system configurations. Such a simulation model takes into account the dynamic operating behavior of the compressors of the simulated compressed air system configuration. The simulation model is based in particular on a set of several time-dependent, preferably partial, differential equations, which are solved in particular by numerical integration methods. Simulation models can be generated automatically on the basis of models for the individual components for each configuration (component-based approach). Alternatively, a universal simulation model for compressed air systems can be used, which is adapted to a specific configuration by parameterization (monolithic approach), wherein components not present in a configuration can be “eliminated” by suitable parameter selection.

For sufficiently accurate simulation results, the control algorithms running in the components, in particular the compressors, and the control algorithms of the central integrated control system are also taken into account, which are modeled for this purpose and represented by the simulation model. Preferably, the control algorithms are adapted in terms of their parameterization to the respective configuration and to constraints to be met. For example, for an integrated control of a certain type, the parameters “demand pressure” and “pressure clearance limit” must be set in such a way that it is possible to comply with the constraints for a necessary minimum pressure and a permissible maximum pressure of the compressed air system. For a compressed air system without an integrated control system, the parameters of the pressure regulators in the compressors are preferably set in such a way that it is possible to comply with the constraints for a necessary minimum pressure and a permissible maximum pressure of the compressed air system and that a realistic switching behavior of the compressors results. Incorrectly set pressure regulators in the simulation model would lead to too frequent switching of the compressors and thus to unrealistically poor results of the energy efficiency of the considered compressed air system configurations compared to compressors in real compressed air systems with correctly set pressure regulators.

Since the generation of the branched data structure B is usually much faster than the complex computer simulations, it may be useful to limit the length of the simulation waiting list (see FIG. 6), e.g. to a maximum of 10 or 100 configurations. If the simulation waiting list is full, the algorithm for generating the data structure B can pause until the simulation waiting list can accommodate configurations again. This ensures that an unnecessarily large number of configurations do not accumulate in the simulation waiting list, even though they do not actually need to be simulated (any longer), because a better currently best configuration has been found in the meantime and the branch to which the configuration belongs could actually have been prevented by restricting the data structure B. Since the individual simulations of the configurations to be performed can be carried out independently of each other, the execution of the computer simulations can be well parallelized. This can speed up the method overall.

At this point it should be noted that all aspects of the invention described above, considered alone and in any combination, are claimed as belonging to the invention, in particular the details shown in the drawings. Modifications thereof are familiar to those skilled in the art.

### LIST OF REFERENCE SIGNS

1 Compressed air system
2, 3 Compressed air path
11, 12, 13 Compressor of the compressed air system
21, 22 Dryer
32, 32 Filter
40 Compressed air tank
50 Consumer
50′ Modeled consumer
60 Plant control
60′ Model of an integrated control system
V1, V2, . . . , Vn Compressor 1 to n of the compressor list
KA1, KA2, . . . , KAm Components 1 to m for compressed air preparation
KS1, KS2, . . . , KSp Components 1 to p for compressed air storage
Kon Compressed air system configuration
Konf, Konf2, . . . , KonfN Compressed air system configurations 1 to N
Konfbest Current best compressed air system configuration
Dk Component data
Dn Constraint data
Dkonf1, Dkonf2 Compressed air system configuration data
Lk Component list
Lv Compressor list
Kt Technical parameter
Kw Economic parameter
B Branched data structure
B0 Highest node level
B1 Higher node level
B2 Lower node level
BEv0 Compressor parent node data structure
Bev1, BEv2, . . . , BEvn Compressor parent node data structure
BKv1, BKv2, . . . , BKvnCompressor child node data structure
GKonfmin Quality value, namely minimum configuration cost value
GBranchmin Quality value, namely minimum branch cost value
GsimCosts Quality value, namely simulated cost value
Gbest Current best quality value
GKonfbest Current best configuration cost value

1-27. (canceled)

28. A method for providing at least one design configuration of a compressed air system comprising at least two compressors connected in parallel, wherein the method comprises:
receiving component data by a computer, wherein the component data indicates components of a compressed air system and at least one technical parameter of each component,
wherein the component data comprise at least one component list with a plurality of functionally identical components of different types and at least one technical parameter assigned to the respective component, wherein a component list is a compressor list containing a plurality of compressors of different types;
generating a branched data structure by the computer, the branched data structure comprises node data structures, which are each assigned to one of at least two node levels, wherein each child node data structure at a lower node level is assigned to a parent node data structure at a higher node level, wherein generating the branched data structure comprises at least the following:
generating, in a memory, a first compressor parent node data structure based on component data of a compressor in the compressor list;
generating, in the memory, a first compressor child node data structure based on component data of a compressor of the compressor list, wherein the first compressor child node data structure is assigned to the first compressor parent node data structure;
generating, in the memory, a second compressor child node data structure based on component data of a compressor of the compressor list, wherein the type of the compressor of the second compressor child node data structure is different from the type of the compressor of the first compressor child node data structure, wherein the second compressor child node data structure is assigned to the first compressor parent node data structure, or
generating, in the memory, a second compressor parent node data structure based on component data of a compressor of the compressor list, wherein the type of the compressor of the second compressor parent node data structure is different from the type of the compressor of the first compressor parent node data structure, and generating, in the memory, a second compressor child node data structure based on component data of a compressor of the compressor list, wherein the second compressor child node data structure is assigned to the second compressor parent node data structure;
generating, by means of a computer, first compressed air system configuration data indicating a first compressed air system configuration in which the compressor of the first compressor parent node data structure and the compressor of the first compressor child node data structure are connected in parallel;
generating, by means of a computer, second compressed air system configuration data indicating a second compressed air system configuration in which the compressor of the first compressor parent node data structure or the compressor of the second compressor parent node data structure and the compressor of the second compressor child node data structure are connected in parallel;
calculating at least one quality value by the computer for at least one of the compressed air system configurations based on the compressed air system configuration data of the compressed air system configuration and at least one technical parameter of the compressors of the compressed air system configuration, wherein the at least one quality value indicates the quality of the compressed air system configuration with respect to a quality criterion specified by a user,
providing at least one compressed air system configuration with at least one assigned quality value each by the computer.

29. The method according to claim 28, further comprising:
receiving constraint data by the computer, wherein the constraint data indicates at least one predetermined constraint by a user, for a compressed air system configuration, and
determining, by the computer, based on the constraint data and the first compressed air system configuration data, whether the first compressed air system configuration satisfies the predetermined constraint and/or, based on the constraint data and the second compressed air system configuration data, whether the second compressed air system configuration satisfies the predetermined constraint,
wherein the at least one quality value is calculated if the respective compressed air system configuration satisfies the predetermined constraint.

30. The method according to claim 29, wherein the at least one predetermined constraint comprises for a compressed air system:
a maximum number of compressors and/or
a maximum number of different compressor types and/or
a specification as to whether variable speed compressors may or must be included.

31. The method according to claim 29, wherein the at least one predetermined constraint comprises for a compressed air system:
the maximum footprint of the compressed air system and/or
a required minimum pressure of the compressed air system and/or
a required maximum pressure of the compressed air system.

32. The method according to claim 29, wherein the at least one predetermined constraint for a compressed air system comprises a maximum investment budget, in particular for the new planning, modification or extension of a compressed air system.

33. The method according to claim 28, wherein the at least one technical parameter of a component, in particular a compressor, comprises:
the energy consumption and/or
a pressure-dependent characteristic curve of the power consumption and/or
a delivery volume flow, in particular at maximum pressure, and/or
a CO₂ emission quantity, especially per compressed air volume.

34. The method according to claim 28, wherein at least one economic parameter of the respective component is assigned to each component in addition to the at least one technical parameter, wherein the economic parameter indicates in particular investment costs and/or maintenance costs of the component, wherein the at least one quality value is calculated in particular on the basis of the at least one technical parameter and at least one economic parameter of at least one compressor of the respective compressed air system configuration.

35. The method according to claim 28, wherein the compressor list comprises at least one compressor of an existing compressed air system and at least one compressor that is not installed in the existing compressed air system.

36. The method according to claim 28, wherein generating the branched data structure further comprises: generating, in a memory, a compressor parent node data structure at the highest node level based on component data of at least one compressor of an existing compressed air system, wherein the compressor parent node data structure of the highest node level is in particular based on component data of compressors of an existing compressed air system and indicates an initial configuration of a compressed air system.

37. The method according to claim 28, wherein the generation of a compressor parent node data structure and/or a compressor child node data structure is additionally based on component data of components for compressed air preparation, in particular a group of components for compressed air preparation, wherein in particular a component list is a list of component groups for compressed air preparation.

38. The method according to claim 29, wherein a constraint for a compressed air system configuration specifies a required minimum differential pressure for compensating a pressure loss of at least one component for compressed air preparation in particular of a group of components for compressed air preparation.

39. The method according to claim 28, wherein the generation of a branched data structure comprises generating, in a memory, at least one further compressor child node data structure at a node level based on component data of a compressor of the compressor list, wherein the type of compressor of the compressor child node data structure to be generated differs from the type of the compressors of the already generated compressor node data structures of this node level which are assigned to the same compressor parent node data structure.

40. The method according to claim 28, wherein the compressors of the compressor list are ordered according to a sorting criterion, wherein for generating a compressor child node data structure which is assigned to a compressor parent node data structure, the component data of compressors are used which are sorted in the compressor list at the same or subordinate list position as the compressor of the compressor parent node data structure.

41. The method according to claim 28, wherein the quality criterion is a cost criterion, wherein the at least one quality value indicates the energy costs and/or investment costs and/or maintenance costs of a compressed air system configuration.

42. The method according to claim 28, further comprising:
comparing two compressed air system configurations based on assigned quality values by a computer; and
storing the compressed air system configuration data of that compressed air system configuration as the currently best compressed air system configuration whose assigned quality value fulfills the quality criterion better, and storing the quality value assigned to the currently best compressed air system configuration as the currently best quality value.

43. The method according to claim 28, wherein calculating the at least one quality value comprises calculating a minimum configuration cost value, which indicates, based on an estimation, a lower bound value for the cost of the compressed air system configuration, wherein the minimum configuration cost value is based on energy costs and/or investment costs of at least one of the components of the compressed air system configuration, wherein the energy costs are calculated based on the energy consumption of the compressor with the highest energy efficiency of a compressor included in the compressed air system configuration, and
wherein the investment costs are calculated as the sum of the investment costs of the compressors included in the compressed air system configuration.

44. The method according to claim 28, wherein calculating the at least one quality value of a compressed air system configuration comprises the calculation of a minimum branch cost value, which, based on an estimation, specifies a lower bound value for the costs of those further compressed air system configurations, in particular not represented in the branched data structure by node data structures, which contain the compressors of the compressed air system configuration,
wherein the minimum branch cost value is based on energy costs of a compressor of the compressor list and/or investment costs of at least one of the components of the compressed air system configuration,
wherein the energy cost is calculated based on the energy consumption of the compressor with the highest energy efficiency of all compressors included in the compressor list, and wherein the investment costs are calculated as the sum of the investment costs of the compressors included in the compressed air system configuration.

45. The method according to claim 28, wherein, based on a quality value assigned to a compressed air system configuration, based on the minimum branch cost value, the generation of further compressor child node data structures of a compressor parent node data structure is excluded or already generated compressor child node data structures of a compressor parent node data structure are deleted, in particular if the minimum branch cost value, satisfies the quality criterion worse than a stored current best quality value assigned to a current best compressed air system configuration.

46. The method according to claim 28, wherein the calculation of a quality value comprises performing a computer simulation and calculating a simulated cost value based on results of the computer simulation, wherein the simulated cost value indicates costs of the compressed air system configuration over a certain operating time, wherein the computer simulation is in particular based on a simulation model of the compressed air system configuration which represents a dynamic behavior of the compressed air system configuration, wherein the simulation model:
takes into account a predetermined time-variable compressed air consumption profile or back pressure profile, specified by a user, as a boundary condition and/or
maps a dynamic operating behavior of at least one compressor of the compressed air system configuration and/or
maps the control behavior of a central control system of the compressed air system, in particular an integrated control system.

47. The method according to claim 28, further comprising storing at least one compressed air system configuration in a simulation waiting list that specifies compressed air system configurations intended for running a computer simulation.

48. The method according to claim 46, wherein computer simulations for different compressed air system configurations are performed in parallel, in particular by different processors or by different groups of processors at least partially simultaneously.

49. The method according to claim 46, wherein generating the branched data structure and a computer simulation for a compressed air system configuration are performed at least partially simultaneously.

50. The method according to claim 28, in particular according to claim 20, further comprising: pausing steps for generating the branched data structure if the number of compressed air system configurations in the simulation waiting list reaches a predetermined maximum number, in particular until the number of compressed air system configurations in the simulation waiting list reaches a value below the maximum number.

51. The method according to claim 28, wherein providing the at least one compressed air system configuration is the output of the optimal compressed air system configuration, wherein in particular its assigned simulated cost value fulfils the quality criterion better than the quality values of all other compressed air system configurations which can be generated based on the compressor list.

52. A computer program product, comprising:
a non-transitory computer readable storage medium comprising computer readable program code embodied in the medium that is executable by a computer to perform operations comprising:
receiving component data by the computer, wherein the component data indicates components of a compressed air system and at least one technical parameter of each component,
wherein the component data comprise at least one component list with a plurality of functionally identical components of different types and at least one technical parameter assigned to the respective component, wherein a component list is a compressor list containing a plurality of compressors of different types;
generating a branched data structure by the computer, the branched data structure comprises node data structures, which are each assigned to one of at least two node levels, wherein each child node data structure at a lower node level is assigned to a parent node data structure at a higher node level, wherein generating the branched data structure comprises at least the following:
generating, in a memory, a first compressor parent node data structure based on component data of a compressor in the compressor list;
generating, in the memory, a first compressor child node data structure based on component data of a compressor of the compressor list, wherein the first compressor child node data structure is assigned to the first compressor parent node data structure;
generating, in the memory, a second compressor child node data structure based on component data of a compressor of the compressor list, wherein the type of the compressor of the second compressor child node data structure is different from the type of the compressor of the first compressor child node data structure, wherein the second compressor child node data structure is assigned to the first compressor parent node data structure, or
generating, in the memory, a second compressor parent node data structure based on component data of a compressor of the compressor list, wherein the type of the compressor of the second compressor parent node data structure is different from the type of the compressor of the first compressor parent node data structure, and generating, in the memory, a second compressor child node data structure based on component data of a compressor of the compressor list, wherein the second compressor child node data structure is assigned to the second compressor parent node data structure;
generating, by means of a computer, first compressed air system configuration data indicating a first compressed air system configuration in which the compressor of the first compressor parent node data structure and the compressor of the first compressor child node data structure are connected in parallel;
generating, by means of a computer, second compressed air system configuration data indicating a second compressed air system configuration in which the compressor of the first compressor parent node data structure or the compressor of the second compressor parent node data structure and the compressor of the second compressor child node data structure are connected in parallel;
calculating at least one quality value by the computer for at least one of the compressed air system configurations based on the compressed air system configuration data of the compressed air system configuration and at least one technical parameter of the compressors of the compressed air system configuration, wherein the at least one quality value indicates the quality of the compressed air system configuration with respect to a quality criterion specified by a user,
providing at least one compressed air system configuration with at least one assigned quality value each by the computer.

53. A server, comprising:
a computer; and
a memory coupled to the computer and comprising computer readable program code embodied in the memory that is executable by the computer to perform operations comprising:
receiving component data by the computer, wherein the component data indicates components of a compressed air system and at least one technical parameter of each component,
wherein the component data comprise at least one component list with a plurality of functionally identical components of different types and at least one technical parameter assigned to the respective component, wherein a component list is a compressor list containing a plurality of compressors of different types;
generating a branched data structure by the computer, the branched data structure comprises node data structures, which are each assigned to one of at least two node levels, wherein each child node data structure at a lower node level is assigned to a parent node data structure at a higher node level, wherein generating the branched data structure comprises at least the following:
generating, in a memory, a first compressor parent node data structure based on component data of a compressor in the compressor list;
generating, in the memory, a first compressor child node data structure based on component data of a compressor of the compressor list, wherein the first compressor child node data structure is assigned to the first compressor parent node data structure;
generating, in the memory, a second compressor child node data structure based on component data of a compressor of the compressor list, wherein the type of the compressor of the second compressor child node data structure is different from the type of the compressor of the first compressor child node data structure, wherein the second compressor child node data structure is assigned to the first compressor parent node data structure, or
generating, in the memory, a second compressor parent node data structure based on component data of a compressor of the compressor list, wherein the type of the compressor of the second compressor parent node data structure is different from the type of the compressor of the first compressor parent node data structure, and generating, in the memory, a second compressor child node data structure based on component data of a compressor of the compressor list, wherein the second compressor child node data structure is assigned to the second compressor parent node data structure;
generating, by means of a computer, first compressed air system configuration data indicating a first compressed air system configuration in which the compressor of the first compressor parent node data structure and the compressor of the first compressor child node data structure are connected in parallel;
generating, by means of a computer, second compressed air system configuration data indicating a second compressed air system configuration in which the compressor of the first compressor parent node data structure or the compressor of the second compressor parent node data structure and the compressor of the second compressor child node data structure are connected in parallel;
calculating at least one quality value by the computer for at least one of the compressed air system configurations based on the compressed air system configuration data of the compressed air system configuration and at least one technical parameter of the compressors of the compressed air system configuration, wherein the at least one quality value indicates the quality of the compressed air system configuration with respect to a quality criterion specified by a user,
providing at least one compressed air system configuration with at least one assigned quality value each by the computer.

54. A terminal device that is configured to perform operations comprising:
transmitting component data to a server, wherein the component data indicates components of a compressed air system and at least one technical parameter of each component, wherein the component data comprise at least one component list having a plurality of functionally identical components of different types and at least one technical parameter assigned to the respective component, wherein a component list is a compressor list which contains a plurality of compressors of different types,
transmitting constraint data indicating at least one constraint for a compressed air system to a server, and/or
transmitting, in particular, a desired compressed air consumption profile for a compressed air system to a server, and/or
indicating, in particular, at least one compressed air system configuration with an assigned quality value.
